(19) United States
(12) Patent Application Publication
(10) Pub. No.: US 2013/0173424 A1
(43) Pub. Date: Jul. 4, 2013

(54) SYSTEM FOR DELIVERING GIFT ITEM USING SOCIAL NETWORK INFORMATION AND METHOD THEREOF

(71) Applicant: Young Min Kwon, Seongnam-si (KR)

(72) Inventor: Young Min Kwon, Seongnam-si (KR)

(73) Assignee: Innodis Co. Ltd., Seoul (KR)

(21) Appl. No.: 13/520,470

(22) PCT Filed: Apr. 20, 2012
(86) PCT No.: PCT/KR2012/003056

§ 371 Date: Jul. 3, 2012

(30) Foreign Application Priority Data
Apr. 20, 2011 (KR) 10-2011-0036456
Jun. 21, 2011 (KR) 10-2011-0060389

(51) Int. Cl. G06Q 30/00

(52) U.S. Cl. 705/26.35

(57) ABSTRACT

A system and method for delivering a gift using social networking information is disclosed. The method for delivering a gift using social-networking information using a gift delivery system which communicates with an orderer UE, a receiver UE, and an SNS server and an online shopping mall server over a wired or wireless commodity network includes a) receiving, by the gift delivery system, information of a commodity to be used as a gift for a receiver and social-networking information other than a reception address of the receiver from the orderer UE connecting to the online shopping mall; b) if payment is completed by the orderer UE, transmitting, authenticating, by the gift delivery system, order information including the commodity information and the receiver, and creating authentication information; c) transmitting, by the gift delivery system, a gift arrival message to the receiver UE; and d) if the receiver UE confirms the gift arrival message, selects reception acceptance, and inputs a reception address, requesting, by the gift delivery system, commodity delivery from a delivery system.

### TECHNICAL FIELD

The present invention relates to a system and method for delivering a gift using social-networking information, and more particularly to a system and method for delivering a gift using social-networking information such as a phone number, e-mail address, social networking service (SNS) account, etc. other than an address of a receiver (or recipient) of the gift.

### BACKGROUND ART

Generally, a conventional system or method for performing gift delivery includes a customer personal computer (PC) used by a person who requests a gift, and a network of a gift delivery service company for sending customer-requested details and associated information to a PC of a person who receives the gift. The network of the gift delivery service company includes a Web server for providing information of the corresponding site to a user, and a mail server for delivering information of a gift requested by the customer PC to a receiver PC. In addition, it is possible for the receiver person to answer the mail transferred over the above-mentioned network using an response message (such as an ACK message), such that the gift receiver can recognize the response message of the gift receiver.

A process for operating/managing the service of the gift delivery service company will hereinafter be described in detail. First of all, after a customer gains access to the corresponding Website managed by the gift delivery service company through his or her PC, the customer searches for a variety of commodities advertised through a page of the Website. Under this condition, if the customer selects a desired gift to commemorate an anniversary or special day and at the same time selects a gift messenger service, a variety of input spaces are displayed. In this case, the customer inputs necessary information to individual input spaces, for example, input spaces of name of message receiver, E-mail address of message receiver, E-mail address of message sender, transmission message, etc. Here, the message receiver is a person who receives the gift requested by the customer. If the customer address is input to the input space transmission message and a specific command transmission is selected, the resultant message is transmitted to a mail box of the gift receiver. Thereafter, if the gift receiver confirms the mail and agrees to receive the gift, purchase expenses of the corresponding gift are paid. In addition, the purchased commodity is delivered to the address requested by the customer through the commodity-selling company, resulting in completion of provision of the gift.

However, considering that the conventional service method is achieved through E-mailing only, it is necessary for a receiver of the gift to confirm his or her E-mail. Particularly, a customer-requested delivery deadline may frequently and unavoidably elapse on the assumption that the receiver of the gift does not frequently check his or her mail box, resulting in the occurrence of a variety of customer dissatisfaction (or consumer complaints). Although the gift receiver receives the message through the above-mentioned message, after the gift receiver connects to the corresponding site and selects the corresponding commodity, a delivery order for the selected commodity must be sent to the customer, resulting in greater inconvenience of use.

A variety of methods for delivering the gift are generally used, for example, parcel post, parcel service and a method for requesting a delivery order from the shop affiliated with the gift delivery service. However, the above-mentioned methods must pre-recognize a recipient address (i.e., a delivery destination address) so as to perform gift delivery. However, assuming that it is difficult to directly query the counterpart person for address information, it is difficult to obtain effectiveness or validity of the gift delivery service due to specialty of gift delivery in a different way from delivery of general commodities. In addition, upon completion of the gift delivery, if the gift receiver serving as the counterpart person does not generate an ACK message, the conventional gift delivery service has difficulty in recognizing whether the gift has been correctly delivered, so that it is necessary for the conventional service manager to directly contact the counterpart person by phone or the like so as to confirm whether the gift is normally delivered to the counterpart person, resulting in greater inconvenience of use.

In addition, a variety of cyber-gift-service sites capable of delivering tangible commodities over the Internet have been widely used. In this case, after a person who orders the gift (hereinafter referred to as the preset orderer) connects to the Internet and purchases a desired commodity as a gift, the gift orderer must input address information of the gift receiver. Particularly, the gift receiver is unable to recognize whether the orderer has purchased the gift for the receiver before completion of the gift delivery, and the gift is mandatorily delivered to the address decided by the orderer so that it is difficult to correctly deliver the gift to the receiver on the condition that the receiver is absent from home at the corresponding date and the corresponding address. Specifically, the gift receiver who does not register as a member in the same service site is unable to receive the gift ordered by the sender serving as the orderer, so that there is a high possibility that personal information of the receiver may be unexpectedly exposed to other people and the gift receiver must mandatorily register as a member of the corresponding site so as to normally receive the gift, resulting in greater inconvenience of the sender and the receiver.

As described above, according to the conventional online-offline process for gift delivery, the orderer of the gift performs an offline purchase step or an online purchase step using PC, smartphone, Internet TV, etc., and must provide not only personal information (e.g., name and phone number) of the orderer of the gift but also address information of the gift receiver to the service providing server, such that the purchase procedure is completed and the delivery step starts operation.

However, the gift orderer must repeatedly confirm whether known address information of the receiver is changed before requesting gift delivery, resulting in greater inconvenience of use. Specifically, if a large amount of commodities are simultaneously delivered due to commemorative events or functions, the sender must manually check address information of all receivers one by one, must also manually input additional information of each receiver, resulting in waste of time, cost and manpower.

Besides the above-mentioned problems causing unnecessary time and cost consumption, since a delivery destination address or a phone number for gift delivery to the receiver is highly personal information, the process for confirming/identifying personal information of the receiver is very difficult and complicated, and there is a tendency that the orderer is generally unwilling to conduct the above confirmation process.

Assuming that the orderer who desires to send some gifts to his or her acquaintances such as friends or teacher do not know address information of the acquaintances, the orderer must manually query the individual acquaintances for their address information before requesting gift delivery, such that the receiver may feel uncomfortable talking with the orderer and the orderer may also feel awkward in talking with the receiver. In addition, while the orderer and the receiver perform transmission/reception of personal information using phones or e-mails, wrong delivery destination information may frequently occur due to erroneous input of information, so that the delivery person of the gift generally makes a phone call to the gift receiver before delivering the gift so as to check whether the address information is correct or wrong. As a result, if it is determined that the address information is correct, then the delivery person delivers the gift to the receiver.

Meanwhile, if the receiver does not want the gift and refuses to receive the gift, the corresponding gift may be returned after delivery completion so that payment of the returned gift is cancelled, resulting in the occurrence of considerably consumptive labor and time. Goods or commodities delivered from a warehouse for gift delivery cannot be recycled due to poor packing, expiration date or the like. In the online shopping mall, if it is impossible for the server of the online shopping mall to deliver the gift because the gift receiver refuses to receive the gift or the address of the receiver is unidentified, the return process and payment cancellation process of the commodity that has already been purchased is completed, the server must provide the orderer with a variety of information regarding the reason of impossible delivery or the purchase cancellation details, resulting in the occurrence of cumbersome affairs.

In addition, the membership registration procedure of the online shopping mall for ordering goods provides a lot of personal information (e.g., name, phone number, address, etc.), such that there is a high danger of unintended personal information exposure.

In recent times, following the current trend of the increasing number of SNS users such as Twitter and Facebook users and the widespread use of smartophones, the scope of SNS-based services and business is rapidly increasing, and many online shopping malls are conducting intensive research into SNS-based social commerce. In fact, the SNS-based social commerce has been used to spread out information of various goods or commodities.

### DISCLOSURE OF INVENTION

### Technical Problem

Therefore, the present invention has been made in view of the above problems, and it is an object of the present invention to provide a system and method for delivering a gift using a minimum of social-networking information such as phone number, e-mail address, social networking service (SNS) account, etc. other than an address of a receiver (or recipient) of the gift.

### Solution to Problem

In accordance with an aspect of the present invention, the above and other objects can be accomplished by the provision of a method for delivering a gift using social-networking information using a gift delivery system which communicates with an orderer user equipment (UE), a receiver UE, and a service networking service (SNS) server and an online shopping mall server over a wired or wireless commodity network, the method including: a) receiving, by the gift delivery system, information of a commodity to be used as a gift for a receiver and social-networking information other than a reception address of the receiver from the orderer UE connecting to the online shopping mall; b) if payment is completed by the orderer UE, transmitting, authenticating, by the gift delivery system, order information including the commodity information and the receiver, and creating authentication information; c) transmitting, by the gift delivery system, a gift arrival message to the receiver UE; and d) if the receiver UE confirms the gift arrival message, selects reception acceptance, and inputs a reception address, requesting, by the gift delivery system, commodity delivery from a delivery system.

In accordance with another aspect of the present invention, a method for delivering a gift to a receiver using social-networking information by an orderer who connects to an online shopping mall through an orderer user equipment (UE) includes: a) if a commodity to be used as a gift for a receiver is selected by the orderer UE, receiving, by a gift delivery connection module, social-networking information other than a reception address from a receiver UE; b) if payment is completed, transmitting, by the gift delivery connection module, order information including commodity information and receiver social-networking information to a gift delivery authentication server; c) authenticating, by the gift delivery authentication server, the order information received from the gift delivery connection module, and creating an authentication URL including an authentication key; d) transmitting, by the gift delivery authentication server, a gift arrival message including the authentication URL to the receiver UE; e) if the receiver UE accesses an authentication URL, selects reception acceptance and inputs reception address information, verifying, by the gift delivery authentication server, commodity reception intention of the receiver and validity of reception address, and transmitting delivery information to the gift delivery connection module upon completion of such verification; and f) requesting, by the gift delivery connection module, commodity delivery from a delivery system.

In accordance with another aspect of the present invention, a method for delivering a gift to a receiver using social-networking information by an orderer who connects to an online shopping mall through an orderer user equipment (UE) includes: a) if a commodity to be used as a gift for a receiver is selected by the orderer UE, receiving, by a gift delivery connection module, social-networking information other than a reception address from a receiver UE; b) if payment is completed, transmitting, by the gift delivery connection module, order information including commodity information and receiver social-networking information to a gift delivery authentication server; c) authenticating, by the gift delivery authentication server, the order information received from the gift delivery connection module, and creating an authentication URL including an authentication key; d) if the gift delivery authentication server transmits the created authentication URL to the gift delivery connection module, creating a gift arrival message including the authentication URL by the gift delivery connection module, and transmitting the created gift arrival message to the receiver UE; e) if the receiver UE accesses an authentication URL and commodity information is requested, verifying, by the gift delivery connection module, validity of the requested commodity information, confirming whether purchase details from the online shopping mall are valid or not after completion of validity verification, creating a file, and transmitting commodity information to the receiver UE; and f) if the receiver UE selects reception acceptance and inputs a reception address, receiving, by the gift delivery connection module, delivery information including the reception address and verifying commodity acceptance intention and validity of the reception address, and transmitting a commodity delivery request to the delivery system after completion of the verification.

In accordance with another aspect of the present invention, a method for delivering a gift to a receiver using social-networking information by an orderer who connects to an online shopping mall through an orderer user equipment (UE) includes: a) if a commodity to be used as a gift for a receiver is selected by the orderer UE, receiving, by a gift delivery connection module, social-networking information other than a reception address from a receiver UE; b) if payment is completed, transmitting, by the gift delivery connection module, order information including commodity information and receiver social-networking information to a gift delivery authentication server; c) authenticating, by the gift delivery authentication server, the order information received from the gift delivery connection module, and creating an authentication URL including an authentication key; d) if the gift delivery authentication server transmits the created authentication URL to the gift delivery connection module, creating a gift arrival message including the authentication URL by the gift delivery connection module, and transmitting the created gift arrival message to the receiver UE; e) if the receiver UE accesses an authentication URL and commodity information is requested, verifying, by the gift delivery authentication server, validity of the requested commodity information, and transmitting a commodity information request to the gift delivery connection module after completion of validity verification; f) confirming, by the gift delivery connection module, whether purchase details from the online shopping mall are valid or not, creating a file, and transmitting commodity information to the receiver UE; and g) if the receiver UE selects reception acceptance and inputs a reception address, receiving, by the gift delivery connection module, delivery information including the reception address and verifying commodity acceptance intention and validity of the reception address, and transmitting a commodity delivery request to the delivery system after completion of the verification.

In accordance with another aspect of the present invention, a method for delivering a gift to a receiver using social-networking information by an orderer who connects to an online shopping mall through an orderer user equipment (UE) includes: a) if a commodity to be used as a gift for a receiver is selected by the orderer UE, receiving, by a gift delivery connection module, social-networking information other than a reception address from a receiver UE; b) if payment is completed, transmitting, by the gift delivery connection module, order information including commodity information and receiver social-networking information to a gift delivery authentication server; c) authenticating, by the gift delivery authentication server, the order information received from the gift delivery connection module, and creating an authentication URL including an authentication key; d) if the gift delivery authentication server transmits the created authentication URL to the gift delivery connection module, creating a gift arrival message including the authentication URL by the gift delivery connection module, and transmitting the created gift arrival message to the receiver UE; e) if the receiver UE accesses an authentication URL and commodity information is requested, verifying, by the gift delivery connection module, validity of the requested commodity information, confirming whether purchase details from the online shopping mall are valid or not after completion of such verification, creating a file, and transmitting commodity information to the receiver UE; f) if the receiver UE selects reception acceptance and inputs a reception address, receiving, by the gift delivery authentication server module, delivery information including the reception address and verifying commodity acceptance intention and validity of the reception address, and transmitting a commodity delivery request to the delivery system after completion of the verification; and g) transmitting, by the gift delivery connection module, a commodity delivery request to a delivery system.

In accordance with another aspect of the present invention, A system for delivering a gift using social-networking information by a gift delivery system which communicates with an orderer user equipment (UE), a receiver UE, and a service networking service (SNS) server and an online shopping mall server over a wired or wireless commodity network includes: a gift delivery connection module, if an orderer selects a commodity to be used as a gift for a receiver in an online shopping mall through the orderer UE, for displaying an information image on the orderer UE in such a manner that the orderer selects/inputs social-networking information other than a reception address of a receiver using the displayed information image; and a gift delivery authentication server for receiving order information including commodity information and social-networking information from the gift delivery connection module, authenticating the received order information, creating an authentication URL, and transmitting a gift arrival message including the authentication URL to the receiver UE.

If the receiver UE accesses an authentication URL, selects reception acceptance and inputs reception address information, the gift delivery authentication server verifies validity of delivery information associated with the selected/input information, transmits the result of verification to the gift delivery connection module, and enables the gift delivery connection module to request commodity delivery from the delivery system on the basis of the transmitted delivery information.

### Advantageous Effects of Invention

Exemplary embodiments of the present invention have the following effects.

From the viewpoint of the orderer of the gift, the number of unnecessary connections to the gift receiver so as to confirm whether the address of the gift receiver is correct can be reduced, such that the orderer can easily deliver the gift to the receiver and the receiver can simply receive the gift without feeling uncomfortable talking with the orderer. The orderer can easily confirm whether the receiver agrees to receive the gift and also confirm the current delivery state of the gift using only a limited amount of personal connection information (also called social-networking information). During various events or promotional events scheduled by enterprises or companies, if it is necessary to deliver event souvenirs or goods to participants or associated members, the embodiments of the present invention need not confirm address information of each person at every delivery time, resulting in reduction of time and costs.

In the meantime, from the viewpoint of the gift receiver, private personal information is transmitted only to the orderer serving as the gift sender, the receiver can conveniently receive the gift ordered by the orderer without providing the receiver's personal information to the orderer and the shopping mall acting as the gift seller. In addition, the embodiments of the present invention can enable the receiver's personal information to be used only for delivery purposes, without exposing the receiver's personal information to the orderer. In addition, address information of each receiver may be stored in a database (DB), such that the receiver can easily utilize the stored address information without inputting his or her address information at every delivery time. Meanwhile, if the receiver does not wish to receive the gift, he or she can also easily refuse the gift. If the receiver accepts or rejects the commodity or gift, he or she can easily send a message of thanks or a message of rejection to the orderer. In addition, through a variety of optional functions of the present invention, the receiver can select a delivery method and a desired delivery time, and can also select a variety of information (e.g., type, color, size, and design) of commodities (gifts).

The orderer and the receiver can easily utilize a variety of applications of the present invention using all kinds of digital devices (e.g., smartphones, feature phones, PCs, smart TVs, tablet PCs, and smart home appliances) at any time and place. Specifically, the embodiments of the present invention can be more efficiently applied not only to PC but also to a variety of smart devices (e.g., smartphones, smart TVs, tablet PCs, and smart home appliances).

Meanwhile, from the viewpoint of the enterprise, assuming that the service of the present invention is introduced to new and conventional shopping malls, the membership registration and the commodity ordering can be achieved using an SNS account (open ID), phone number, and E-mail, such that the enterprise who uses the inventive service can rapidly increase the number of service users or subscribers. In addition, financial costs requisite for improving operation/management of the conventional shopping mall system can be minimized.

Furthermore, the embodiments of the present invention can allow the service user to conduct the gift delivery service through shopping, and can easily collect necessary information such as personal address information using questionnaire or acceptance procedures.

### BRIEF DESCRIPTION OF DRAWINGS

The accompanying drawings, which are included to provide a further understanding of the invention, illustrate embodiments of the invention and together with the description serve to explain the principle of the invention.

FIG. 1 is a conceptual diagram illustrating a gift delivery system using social-networking information according to an embodiment of the present invention.

FIG. 2 is a flowchart illustrating a gift delivery method using social-networking information according to an embodiment of the present invention.

FIG. 3 is a block diagram illustrating a gift delivery system using social-networking information according to a first embodiment of the present invention.

FIG. 4 is a flowchart illustrating the step of receiver decision shown in FIG. 2.

FIG. 5 is a flowchart illustrating the step of order information authentication and authentication URL creation shown in FIG. 2.

FIG. 6 is a flowchart illustrating the step of gift arrival message transmission shown in FIG. 2.

FIG. 7 is a flowchart illustrating the steps of message confirmation, commodity information request, and commodity information validity verification of FIG. 2.

FIG. 8 is a flowchart illustrating commodity-receipt acceptance or denial of FIG. 2.

FIG. 9 is a block diagram illustrating the operations of the gift delivery system using social-networking information according to a second embodiment of the present invention.

FIG. 10 is a block diagram illustrating the operations of the gift delivery system using social-networking information according to a third embodiment of the present invention.

FIG. 11 is a block diagram illustrating the operations of the gift delivery system using social-networking information according to a fourth embodiment of the present invention.

FIGS. 12 to 22 illustrate detailed service application examples of the gift delivery system and method according to embodiments of the present invention.

### MODE FOR THE INVENTION

Hereinafter, other purposes, characteristics and other beneficial features of the present invention will become apparent from the following detailed description with reference to illustrative examples, taken in conjunction with the accompanying drawings. Exemplary embodiments of the present invention to achieve the above objects will be described in detail in the following description with reference to the accompanying drawings.

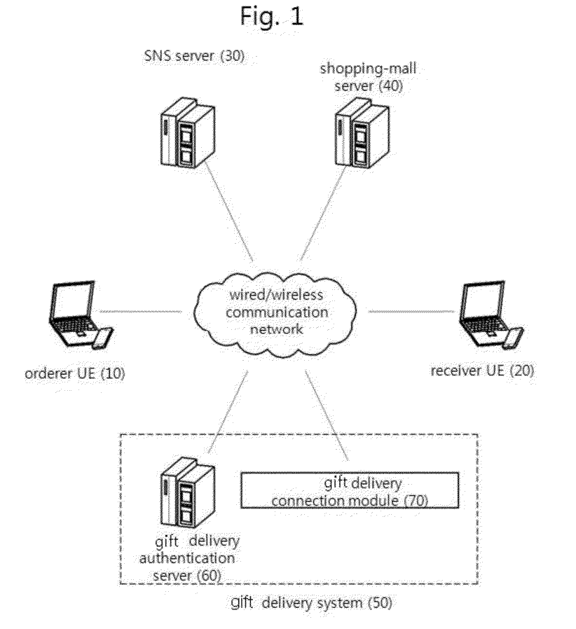

FIG. 1 is a conceptual diagram illustrating a gift delivery system using social-networking information according to an embodiment of the present invention. Referring to FIG. 1, the gift delivery system 50 according to the embodiment of the present invention can communicate with an orderer (sender) user equipment (UE) 10, a receiver UE 20, a social networking service (SNS) server 30, and an online shopping mall server 40 over a wired or wireless communication network. The gift delivery system includes a gift delivery authentication server 60 and a gift delivery connection module 70.

The term online shopping mall used in the present invention conceptually includes not only general online shopping malls, but also smart shopping (such as TV home shopping, social commerce, and IPTV shopping).

All kinds of digital communication devices may be used as the orderer UE 10 and the receiver UE 20. Preferably, mobile phone, smart phone, PC, tablet PC, smart TV, smart home appliances and the like may be used as any of the order UE 10 and the receiver UE 20.

Configuration and function of the orderer UE 10, the receiver UE 20, and the wired/wireless communication network are well known to those skilled in the art, and deviates from the principal range of the present invention, and as such a detailed description thereof will herein be omitted for convenience of description.

If the orderer selects a commodity to be used as a gift for the receiver in the online shopping mall using the orderer UE 10, the gift delivery connection module 70 requests personal connection information (i.e., social-networking information) from the gift delivery authentication server 60 so as to enable the orderer to select a desired receiver, receives the social-networking information from the gift delivery authentication server 60, and provides the list of social-networking information on the screen of the orderer UE 10. Meanwhile, the gift delivery connection module 70 does not request the social-networking information from the gift delivery authentication server 60, and directly requests the list of social-networking information from the SNS server 30, such that it can directly provide the received social-networking information to the orderer UE 10.

If the orderer UE 10 is a mobile phone or smartphone, the operating system (OS) of the mobile phone or smart phone supports application program installation, such that the orderer UE 10 can install an application program dedicated for gift delivery therein and then conveniently use the installed application. In addition, the orderer UE 10 may connect to the Internet Web services so as to implement a necessary connection module.

In addition, under the condition that the connection module is implemented using a PC or smart TV (for example, using application installation or the same-environment program), the orderer connects to the Internet shopping mall server or Website using the PC or smart TV in such a manner that the orderer can select a commodity to be used as a gift and input social-networking information of the receiver.

Provided that the UE is a feature phone, it is very difficult to install other applications excluding embedded programs decided in the product fabrication process into the feature phone, differently from the mobile phone or smart phone. In this case, the UE may connect to the Internet Web service so as to implement the connection module.

In addition, the smart home appliances refer to specific home appliances (such as a smart TV) having a smart function for enabling home appliances (for example, a refrigerator, oven, etc.) to perform bidirectional communication. A connection module of the smart home appliances can also be implemented through the Internet Web service.

The gift delivery connection module 70 implemented by the orderer UE supports the Open API using socket communication, and supports all the communication schemes including 3-tiers (Server, Middleware, Client)-based socket communication and HTTP communication (xml, json, etc.). Therefore, when using the gift delivery connection module of the present invention, time and costs required for improving the operation/management of the existing shopping mall system can be minimized.

The term social-networking information defined by the present invention includes the remaining information other than address information. For example, the social-networking information may include any of an SNS account, phone number, and e-mail address.

If the gift delivery connection module 70 requests the social-networking information list of the receiver from the gift delivery authentication server 60, the gift delivery authentication server 60 requests social-networking information of the SNS account from the SNS server 30, and delivers the received social-networking information of the SNS account to the gift delivery connection module 70. Meanwhile, as described above, the gift delivery connection module 70 can request the social-networking information list from the SNS server 30 without using the gift delivery authentication server 60.

If the orderer selects a commodity to be used as a gift and social-networking information of the receiver, the gift delivery connection module 70 transmits the selected information (order information) to the gift delivery authentication server 60, so that the gift delivery authentication server 60 can transmit authentication information of the order information to the receiver UE 20.

The gift delivery authentication server 60 selectively or mixedly performs validity confirmation, authentication key creation, and encryption of the order information sent from the gift delivery connection module 70. For example, the gift delivery authentication server 60 authenticates validity of the shopping-mall server or website, and creates an authentication key, and encrypts authentication basic information of the receiver and the commodity information in such a manner that authentication information is created and transmitted to the receiver UE. For example, it is preferable that the authentication information is a URL on the Internet. For example, if a connection module or an application interacting with the connection module is not contained in the receiver UE, download URL address information of the application for enabling a user to input a delivery address is received, such that the application is installed on the receiver UE and authentication information confirmation is achieved.

The gift delivery authentication server 60 creates and stores authentication information (i.e., authentication URL including an authentication key). The gift delivery message including the authentication URL is sent to the receiver UE 20 or the gift delivery connection module 70. On the other hand, although the gift delivery authentication server 60 may transmit a gift arrival message including an authentication URL to the receiver UE 20, if the gift delivery authentication server 60 creates/stores authentication information and transmits the stored information to the gift delivery connection module 70, the gift delivery connection module 70 generates the gift arrival message and transmits it to the receiver UE 20. However, it should be noted that the scope of the present invention is not limited thereto and can be applied to other examples as necessary.

If the gift arrival message is transmitted, the receiver confirms the gift arrival message and requests commodity information from the server. The gift delivery authentication server 60 or the gift delivery connection module 70 verifies validity of a person requesting the commodity information.

The gift delivery connection module 70 requests commodity information from the shopping mall server and receives the commodity information, such that it transmits the received information to the receiver UE.

Meanwhile, if the receiver who uses his or her UE may input the approval or denial message of the commodity, a reception address, a transmission message, or the like, the gift delivery authentication server 60 or the gift delivery connection module 70 verifies validity of such commodity-receipt decision-making, commodity-receipt address, transmission message, etc.

Upon completion of the verification step, the gift delivery connection module 70 transmits a commodity delivery request or payment cancellation request to the delivery system or the shopping mall server.

A method for delivering the gift using social-networking information and the aforementioned gift delivery system capable of communicating with the orderer UE 10, the receiver UE 20, the SNS server 30 and the online shopping mall server 40 over a wired or wireless communication network includes: a) receiving not only information of a commodity to be used as a gift for a receiver but also social-networking information other than a reception address of the receiver from the orderer UE connecting to the online shopping mall; b) if payment from the orderer UE is completed, allowing the gift delivery system to authenticate order information including the commodity information and the receiver information; c) allowing the gift delivery system to transmit a gift arrival message to the receiver UE; and d) if the gift arrival message is received from the receiver UE, and if a reception acceptance message is selected and a desired reception address is input by the receiver UE, allowing the gift delivery system to request commodity delivery from a delivery system.

As described above, authentication information may be included in the gift arrival message or may be separated from the gift arrival message as necessary. Preferably, authentication information may be an authentication URL including an authentication key. Therefore, confirming the gift arrival message may include accessing the authentication information as necessary.

Various embodiments of the present invention will hereinafter be described with reference to the annexed drawings.

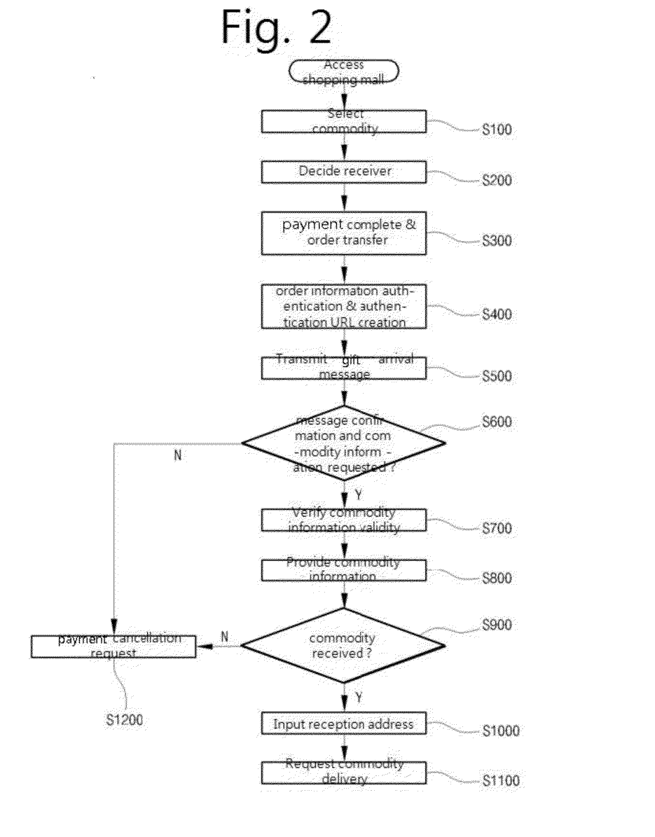

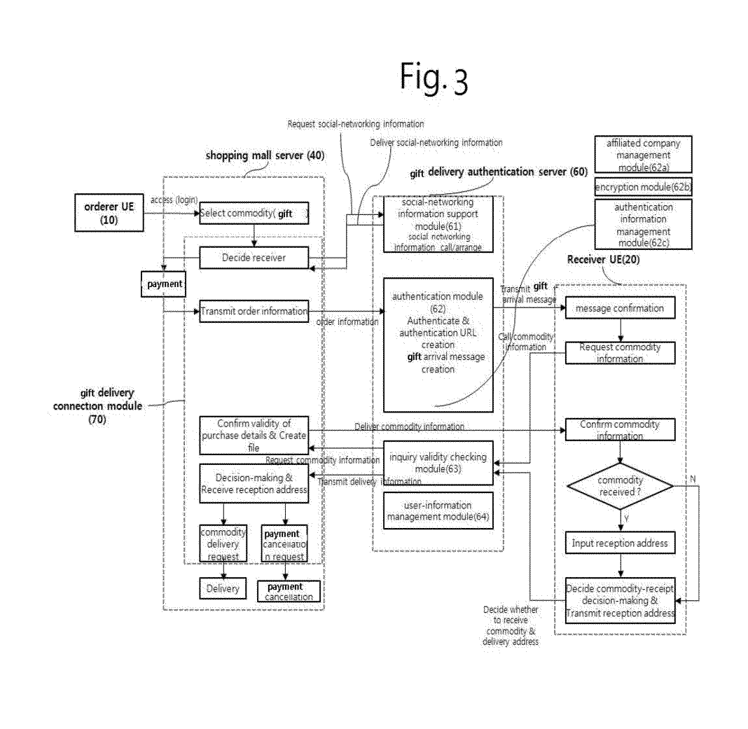

The system and method for delivering the gift according to a first embodiment of the present invention will hereinafter be described with reference to FIGS. 2 and 3.

Referring to FIG. 3, the gift delivery connection module 70 directs the orderer to directly input and decide a receiver of the gift, and transmits order information of the orderer who has conducted payment completion to the gift delivery authentication server 60. On the other hand, upon receiving the commodity information request, the gift delivery connection module 70 confirms the presence or absence of validity of purchase details through the online shopping mall, generates a necessary file, and transmits the commodity information to the receiver UE 20. The gift delivery connection module 70 receives decision-making information indicating the acceptance or denial of the gift from the gift delivery authentication server 60, or receives delivery information from the gift delivery authentication server 60, such that it requests commodity delivery from either the online shopping mall or the delivery system or transmits a payment cancellation request to the online shopping mall.

If the gift delivery authentication server 60 receives a request of the social-networking information list from the gift delivery connection module 70, it calls, arranges, and transmits the list. Upon receiving the order information from the gift delivery connection module 70, the gift delivery authentication server 60 authenticates the order information, creates the authentication URL, creates the gift arrival message, and verifies validity of inquiry. In more detail, the gift delivery authentication server 60 includes a social-networking information support module 61, an authentication module 62, an inquiry validity checking module 63, and a user-information management module 64.

The social-networking information support module 61, if the orderer selects receivers of the gift, displays the list of objective receivers for convenience of the orderer. The social-networking information support module 61 calls social-networking information of the orderer from each SNS server 30 on the basis of information of the orderer, such that it can allow the orderer to easily select desired receivers. The social-networking information support module 61 confirms whether the orderer logs in to the SNS account. If the orderer logs in to the SNS account, the social-networking information support module 61 generates social-networking information call page composed of the corresponding SNS API, calls social-networking information from the SNS server, and reads necessary data. If the orderer does not log in to the SNS account, a current screen image is changed to a login connection screen image such that the orderer can complete the login process using the login connection screen image. The social-networking information support module 61 arranges and fabricates the read data so as to configure a list page, transmits the list page to the gift delivery connection module 70, and displays the list page on the orderer UE.

On the other hand, the gift delivery connection module 70 does not request social-networking information from the gift delivery authentication server 60, directly requests the list of social-networking information from the SNS server 30, receives the social-networking information list from the SNS server 30, and provides the received social-networking information to the orderer UE 10. In this case, the embodiments of the present invention need not use the social-networking information support module 61.

The authentication module 62 authenticates the order information including purchase information and receiver information, and creates an authentication URL. The authentication module 62 confirms whether the shopping mall has been registered in the authentication server 60, and manages the shopping mall. The authentication module 62 includes a member-company (i.e., affiliated company) management module 62 for storing/managing information of the member company; an encryption module 62b for encrypting SNS information of the receiver on the condition that the orderer wants to transmit purchase information and receiver information through the online shopping mall; and an authentication information management module 62c for creating an authentication URL including an authentication key on the condition that the orderer selects not only a commodity to be used as a gift but also social-networking information so as to purchase the commodity, and storing reception information in a database (DB) after creating the authentication key.

In the case where a person serving as the receiver queries commodity information and inputs information of acceptance or denial of the gift and his or her address information, the inquiry validity checking module 63 confirms whether or not this receiver is a correct receiver.

In order to prevent the receiver who accepts the gift and transmits his or her address information from repeatedly inputting his or her address information at every delivery, the user-information management module 64, if address information is automatically registered according to the receiver's agreement procedure, stores and manages the registered address information.

A method for delivering a gift using social-networking information by means of the aforementioned system according to one embodiment of the present invention will hereinafter be described with reference to FIGS. 2 to 8.

Referring to FIG. 2, the orderer gains access to the online shopping mall using the orderer UE. If the orderer selects a commodity to be used as a gift in the online shopping mall in step S100, the gift delivery connection module provides social-networking information in such a manner that the orderer can decide social-networking information of a receiver scheduled to receive the gift (Step S200).

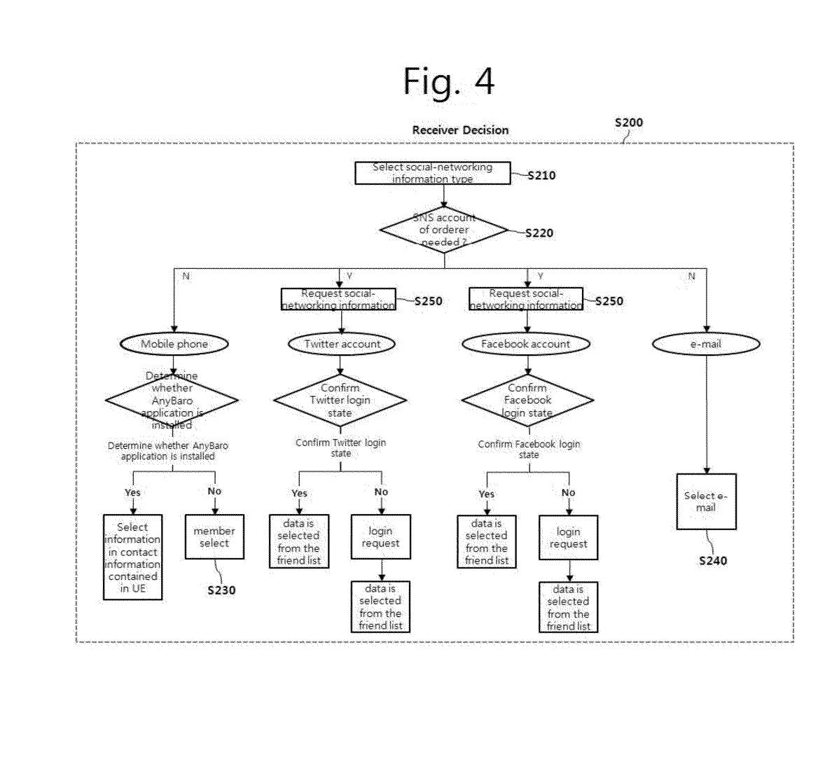

The step for deciding the receiver social-networking information will hereinafter be described with reference to FIG. 4. If the orderer selects a desired commodity and performs the service of the present invention, the orderer must input social-networking information. In more detail, the orderer selects the type of social-networking information (step S210), and determines whether or not the SNS account of the orderer is needed (Step S220). The orderer may directly input the receiver social-networking information or select the type of social-networking information. The gift delivery connection module provides the social-networking information list when the orderer selects the type of social-networking information.

Under the condition that the social-networking information is a mobile phone number (or phone number) and the gift-delivery dedicated application is installed on the orderer UE, if the list is retrieved from the contact information stored in the UE and the retrieved list is displayed on the orderer UE, the orderer can select the contact information from the list. If the service application is not installed, the orderer may directly input contact information (Step S230). If the social-networking information is an e-mail address, the orderer can directly input the e-mail address (Step S240).

On the other hand, if the social-networking information is an open ID of an SNS account (for example, Twitter, Facebook, Yozm, MySpace, Kakao Talk, Olleh Talk), the gift delivery connection module 70 requests the social-networking information list from the gift delivery authentication server 60 (Step S250). The gift delivery authentication server 60 confirms SNS login information of the orderer. If the orderer logs in to the SNS server, the gift delivery authentication server 60 requests social-networking information (a list of friends) from the SNS server, receives the requested social-networking information, arranges the received social-networking information, and transmits the arranged social-networking information to the gift delivery connection module 70. The gift delivery connection module 70 displays the transmitted social-networking information list on the orderer UE 10 so as to enable the orderer to select desired information. If the orderer logs out of the server, the gift delivery connection module 70 directs the orderer to log in to the server such that the corresponding task can be carried out.

In the meantime, as previously stated above, the gift delivery connection module 70 does not request social-networking information from the gift delivery authentication server 60, directly requests social-networking information from the SNS server 30, receives the social-networking information from the SNS server 30, and provides the received social-networking information to the orderer UE 10. In this case, the above-mentioned functions of the gift delivery authentication server 60 are not carried out.

Referring back to FIG. 2, if payment of the orderer is completed, the gift delivery connection module 70 transmits order information including commodity information and receiver social-networking information to the gift delivery authentication server 60 (Step S300), and the gift delivery authentication server 60 authenticates the order information and creates an authentication URL including an authentication key (Step S400).

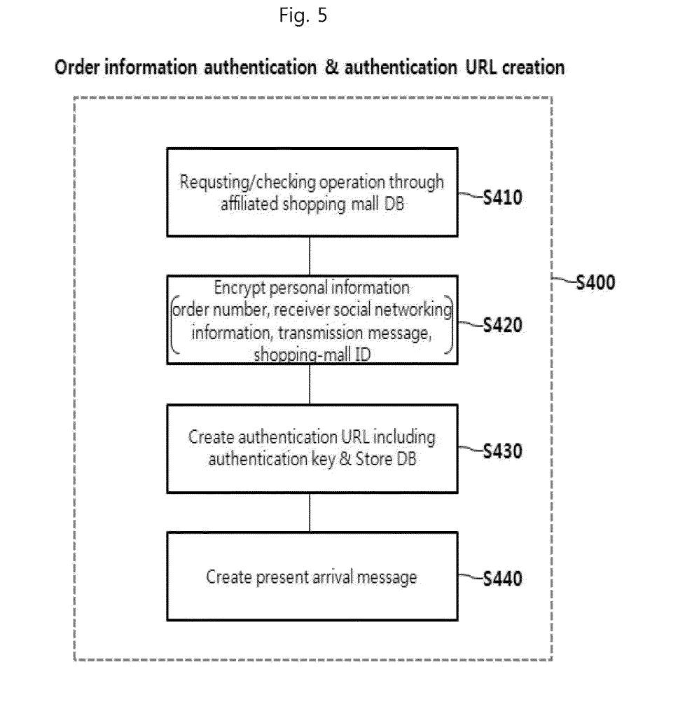

The authentication and authentication URL creation step will hereinafter be described with reference to FIG. 5. Referring to FIG. 5, it is determined whether the corresponding shopping mall is an affiliated shopping mall (i.e., a member shopping mall) through a member shopping-mall database (Step S410), and personal information including order information is encrypted (Step S420). The personal information including the order information may include commodity information (order number), receiver social-networking information, a transfer message written by the orderer or a pre-stored transfer message, and the corresponding shopping mall ID. In addition, the gift delivery authentication server encrypts such order information, creates an authentication URL including an authentication key, and stores the resultant information in the DB (Step S430). The authentication URL may be any one of a download address of an application for directing the receiver to input a reception address using the receiver UE, a URL of a site for informing the gift delivery system of the acceptance or denial message of the receiver, or a URL address for connecting to the gift delivery system. Thereafter, the gift arrival message is created (Step S440).

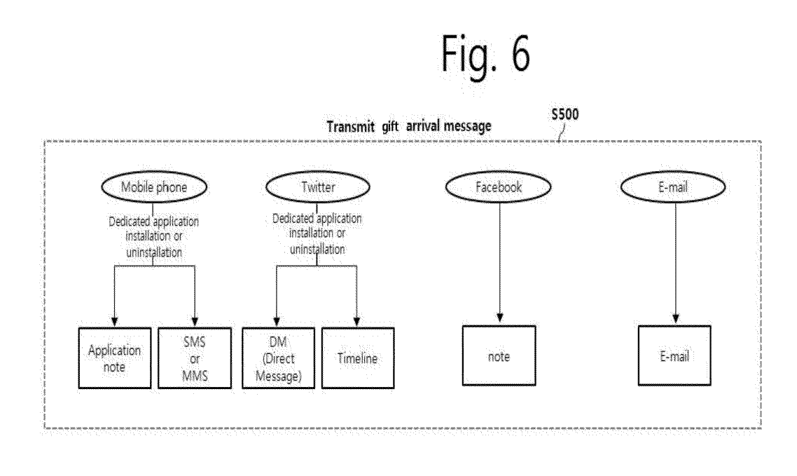

Referring back to FIG. 2, the gift delivery authentication server 70 transmits a gift arrival message including the created authentication URL to the receiver UE (Step S500). The gift arrival message is changed according to social-networking information types, and a detailed description thereof will hereinafter be given with reference to FIG. 6. Provided that the social-networking information is a mobile phone number and a dedicated application is installed, the gift arrival message is transmitted as a note of the dedicated application. If the dedicated application is not installed, the gift arrival message may be transmitted as an SMS/MMS message. If the social-networking information is the e-mail address, the gift arrival message is delivered to the corresponding e-mail address. On the other hand, if the social-networking information is an SNS account, the gift arrival message may be transmitted using the corresponding SNS note. However, if the SNS account is Twitter, the gift delivery authentication server 70 confirms the presence or absence of following and following back, and confirms whether DM (Direct Message) delivery is possible. If DM delivery is possible, the gift delivery authentication server 70 sends the DM. If DM delivery is impossible, the gift delivery authentication server 70 sends the gift arrival message through mention.

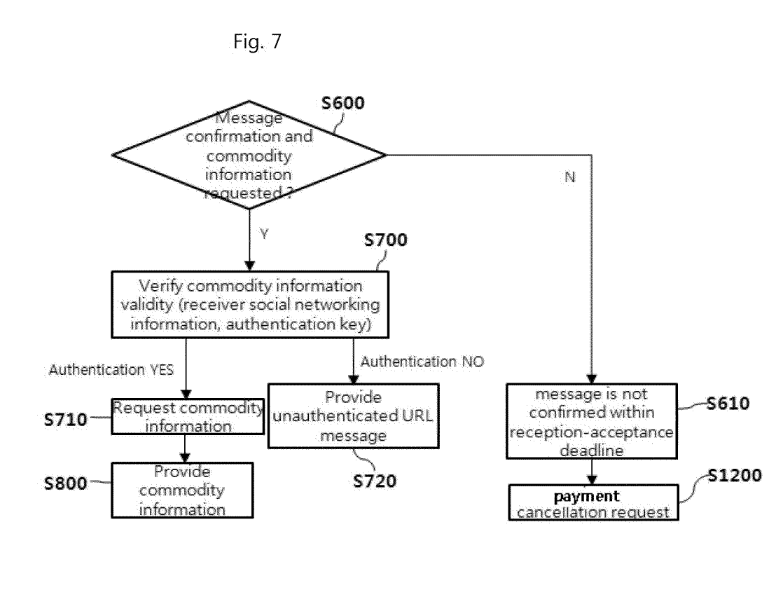

Referring back to FIG. 2, upon transmission completion of the gift arrival message, the receiver confirms the gift arrival message and requests commodity information (Step S600), and a detailed description of the above-mentioned operation 5600 will hereinafter be given with reference to FIG. 7. If the orderer UE gains access to the authentication URL and requests commodity information (Step S600), the gift delivery authentication server 60 verifies the validity of commodity information using the receiver social-networking information and the authentication key (Step S700).

If authentication has been completed or succeeded, the gift delivery authentication server 60 requests commodity information from the gift delivery connection module 70, and the gift delivery connection module 70 requests commodity information from the online shopping mall and transmits the received commodity information to the receiver UE (Step S800). Even in the case where information is received from the online shopping mall and the received information is transmitted to the receiver UE, such verification process may also be performed again. The commodity information may include a variety of information, for example, a commodity picture, a commodity name, a purchase shopping mall, an orderer, a transfer message, reception-acceptance deadline, etc. If the validity of commodity information is not verified, an unauthenticated URL message is provided. If the receiver does not confirm the gift delivery message within the reception-acceptance deadline or does not access the authentication URL (Step S610), the payment cancellation request is sent (Step S1200).

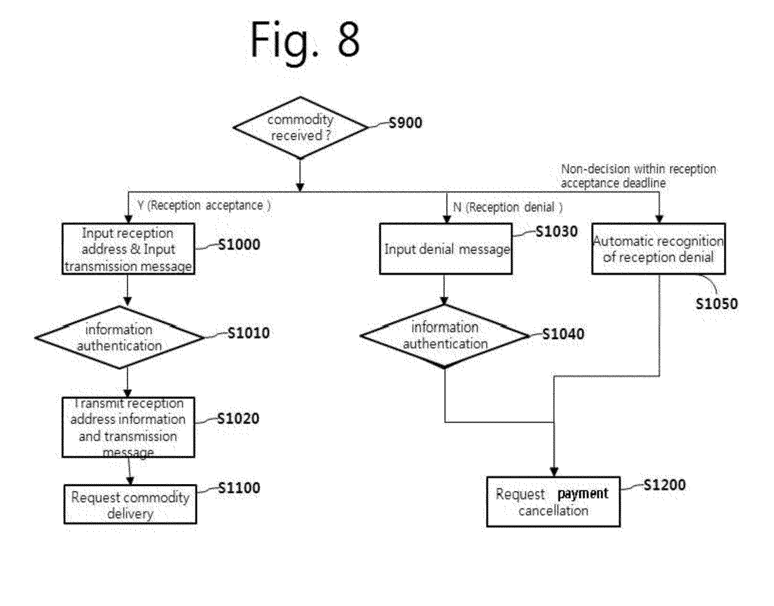

Referring back to FIG. 2, the orderer who receives the commodity information desires to receive the gift (Step S900), selects reception acceptance, and then inputs the delivery address (Step S1000). If the orderer does not want the gift, and the orderer selects reception denial and inputs a denial message, the gift delivery connection module 70 transmits a payment cancellation request (Step S1200), and a detailed description thereof will hereinafter be given with reference to FIG. 8.

If the receiver wants the gift, he or she inputs reception acceptance and delivery address information. In addition, the receiver may also input a transmission message (Step S1000). In this case, the gift delivery authentication server 70 authenticates input information (Step S1010), and transmits delivery information to the gift delivery connection module 60. The gift delivery connection module transmits the delivery information and the transmission message to the gift delivery connection module (Step S1020). The gift delivery connection module receives the delivery information and commands the delivery system to start commodity delivery (Step S1100). Requesting commodity delivery from the delivery system may include a first case in which delivery information is delivered to the online shopping mall, a second case in which the online shopping mall transmits delivery information to the delivery company so as to start commodity delivery, and a third case in which delivery information is directly delivered to the delivery company so as to start commodity delivery.

Meanwhile, if the receiver does not want the gift, he or she refuses to receive the gift and inputs a denial message (Step S1030). If the receiver inputs the denial message, the gift delivery authentication server 60 authenticates input information (Step S1040), and transmits an order cancellation request to the gift delivery connection module. Upon receiving the order cancellation request, the gift delivery service module 70 requests a payment cancellation request from the online shopping mall (Step S1200). If the transmission message of step S1000 and the denial message of step S1030 are not separately entered by the receiver, the gift delivery authentication server 60 may transmit a pre-stored transmission message or denial message to the orderer UE.

On the other hand, if the gift arrival message from the receiver is not confirmed during a predetermined time, if the authentication URL is not accessed (Step S610, See FIG. 7), or if reception acceptance is not input during a predetermined time (Step S1050), this means that the receiver does not want the gift or is unable to receive the gift, such that the gift delivery authentication server 60 requests order cancellation from the gift delivery connection module, and the gift delivery service module 70 having received the order cancellation request transmits a payment cancellation request from the online shopping mall (Step S1200).

The gift delivery connection module calls the current delivery situation of the commodity from the shopping mall server or the delivery system, such that it can transmit a variety of messages (e.g., ‘on delivery’ and ‘delivery over’ messages, etc.) to the receiver UE.

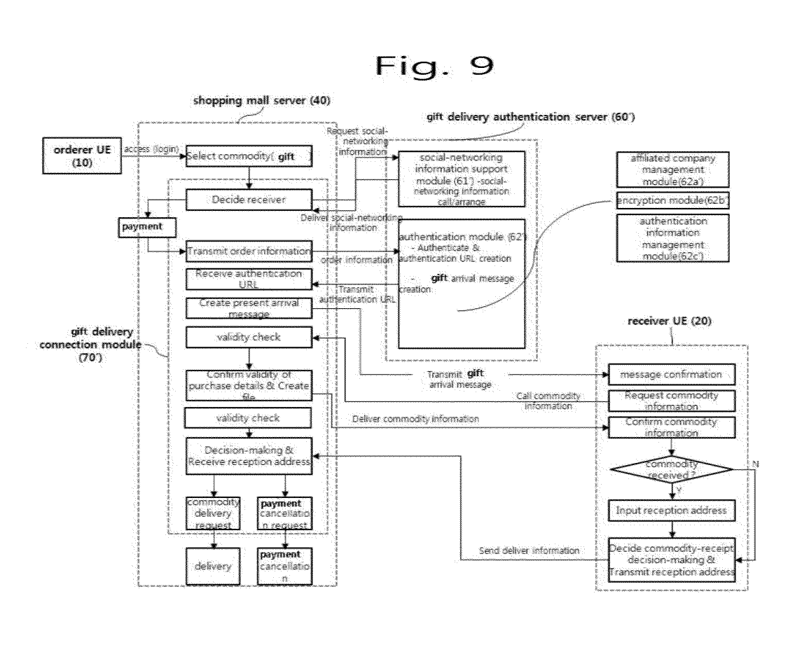

FIG. 9 is a block diagram illustrating the operations of the gift delivery system using social-networking information according to a second embodiment of the present invention. Referring to FIG. 9, the gift delivery system according to the present invention includes a gift delivery authentication server 60′ and a gift delivery connection module 70′. The gift delivery authentication server 60′ also includes the social-networking information support module 61′ and the authentication module 62′ in the same manner as in the first embodiment. The social-networking information support module 61′ configures the social-networking information list, and transmits the same to the gift delivery connection module 70′. The authentication module 62′ receives the order information, authenticates the order information, and creates an authentication URL including an authentication key. Compared to the first embodiment of FIG. 3, the gift delivery authentication server 60′ does not include the inquiry validity checking module, such that the inquiry validity checking function is not carried out. This validity checking is conducted by the gift delivery connection module 70′

The gift delivery method using social-networking information according to the second embodiment of the present invention will hereinafter be described with reference to FIGS. 2 and 9. The same reference numerals as those in the above first embodiment regift the same elements, and thus, a detailed description of the same elements will be omitted.

The orderer connects to the shopping mall server 40 through the orderer UE, and selects the corresponding commodity (Step S100). Thereafter, if the gift delivery connection module 70′ selects social-networking information and the social-networking information support module 61′ of the gift delivery authentication server 60′ requests social-networking information from the SNS server, arranges the requested information, and transmits the arranged information to the gift delivery connection module 70′, the gift delivery connection module 70′ displays the received information on the orderer UE so as to direct the orderer to decide (directly input or select) a receiver (Step S200). Then, if the orderer pays for commodity costs, the gift delivery connection module 70′ transmits order information to the gift delivery authentication server 60′. Steps S100, S200, and S300 are identical to those of the first embodiment.

On the other hand, if the authentication module 62′ of the gift delivery authentication server 60′ creates the authentication and authentication URL (Step S400) and transmits the created information to the gift delivery connection module 70′, the gift delivery connection module 70′ receives the authentication URL, creates a gift arrival message including the authentication URL, and transmits the gift arrival message to the receiver UE 20 (Step S500).

If the receiver UE performs message confirmation and requests commodity information (Step S600), the gift delivery connection module 70′ verifies validity of commodity information of a requesting person (Step S700), and provides the commodity information to the receiver UE 20 (Step S800).

If the receiver accepts commodity reception (Step S900) and inputs his or her address (Step S1000), the gift delivery connection module 70′ verifies validity of delivery information of a requesting user, and requests commodity delivery from the delivery system including the online shopping mall (Step S1100). If message confirmation is not achieved or if the purchase user refuses to receive the commodity, the gift delivery connection module 70′ transmits a payment cancellation request to the online shopping mall (Step S1200).

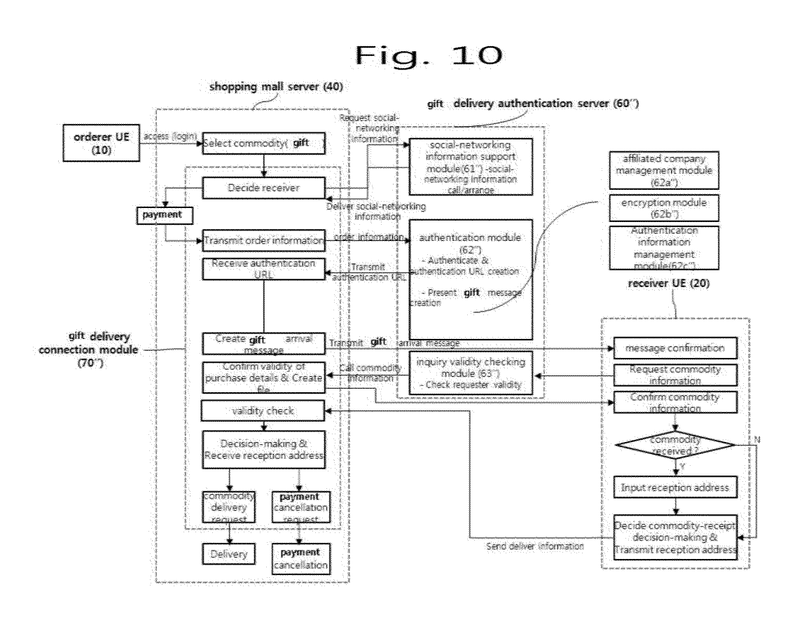

FIG. 10 is a block diagram illustrating the operations of the gift delivery system using social-networking information according to a third embodiment of the present invention. Referring to FIG. 10, the system of the third embodiment may include an authentication server 60″ and the gift delivery connection module 70″. Compared to the second embodiment, the gift delivery authentication server 60″ of the third embodiment further includes the inquiry validity checking module 63″. The inquiry validity checking module 63″ verifies commodity information inquiry validity of the person who requests the commodity information.

The gift delivery method using social-networking information according to the third embodiment of the present invention will hereinafter be described with reference to FIGS. 2 and 10. The same reference numerals as those in the above second embodiment regift the same elements, and thus, a detailed description of the same elements will be omitted.

The commodity selection step S100, the receiver decision step S200, the payment completion and order information transmission step S300, the payment completion and order information transmission step S300, the order information authentication and authentication URL creation step S400, and the gift arrival message transmission step S500 of the third embodiment are identical to those of the second embodiment.

If the receiver UE performs message confirmation and requests commodity information (Step S600), the gift delivery authentication server 60″ having received the requested information verifies validity of commodity information of a requesting person (Step S700), and calls the commodity information from the gift delivery connection module 70″. The gift delivery connection module 70″ having received the called commodity information transmits commodity information to the receiver UE 20 (Step S800).

The commodity reception acceptance or denial step S900, the reception address input step S1000, the commodity delivery requesting step S1100, and the payment cancellation requesting step S1200 of the third embodiment are identical to those of the second embodiment.

FIG. 11 is a block diagram illustrating the operations of the gift delivery system using social-networking information according to a fourth embodiment of the present invention. Referring to FIG. 11, the system of the fourth embodiment may include the gift delivery authentication server 60′″ and the gift delivery connection module 70′″. Compared to the second embodiment of FIG. 9, the gift delivery authentication server 60′″ further includes the inquiry validity checking module 63′, and the inquiry validity checking module 63′ verifies receiver intention regarding the acceptance or denial of the commodity and the requester validity of delivery information.

The gift delivery method using social-networking information according to a fourth embodiment of the present invention will hereinafter be described with reference to FIGS. 2 and 11.

The same reference numerals as those in the above first embodiment regift the same elements, and thus, a detailed description of the same elements will be omitted.

In FIG. 11, the commodity selection step S100, the receiver decision step S200, the payment completion and order information transmission step S300, the order information authentication and authentication URL creation step S400, the gift arrival message transmission step S500, the message confirmation and commodity information requesting step S600, the commodity information validity verification step S700, and the commodity information providing step S900 are identical to those of the second embodiment.

On the other hand, if the receiver accepts commodity reception (Step S900) and inputs his or her address (Step S1000), the gift delivery authentication server 60′″ verifies validity of delivery information of a requester and transmits the verified result to the gift delivery connection module 70′″. The gift delivery connection module 70′″ requests commodity delivery from the delivery system including the online shopping mall (Step S1100). If the purchaser refuses to receive the commodity, the gift delivery authentication server 60′″ checks validity of such commodity denial, and transmits the checked result to the gift delivery connection module 70′″. The gift delivery connection module 70′″ having received the validity checking result transmits a payment cancellation request to the online shopping mall (Step S1200).

Detailed service application examples of the gift delivery system and method of the present invention will hereinafter be described in detail. For convenience of description and better understanding of the present invention, it is assumed that each of the orderer UE and the receiver UE is a smartphone.

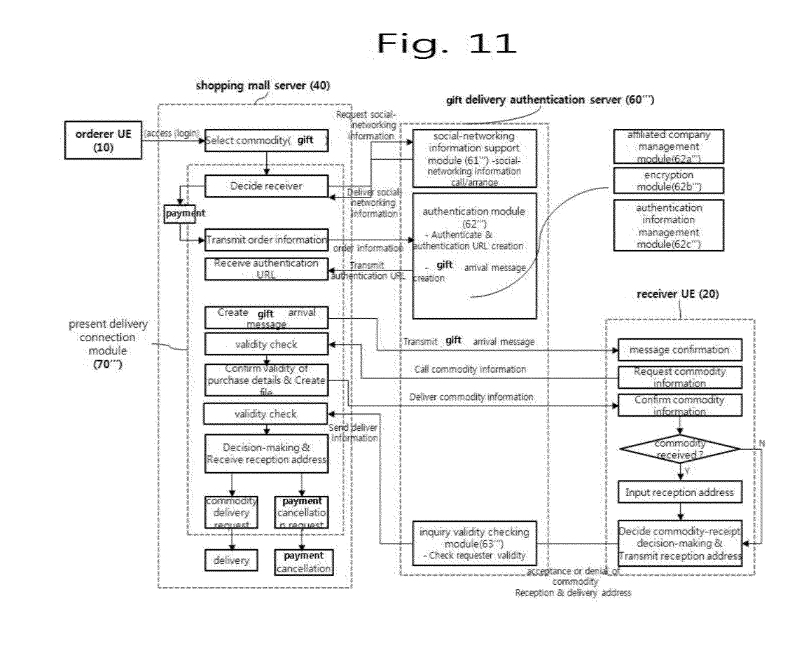

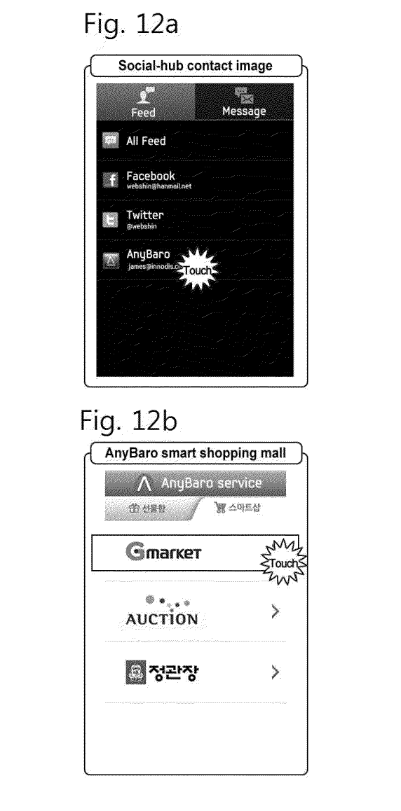

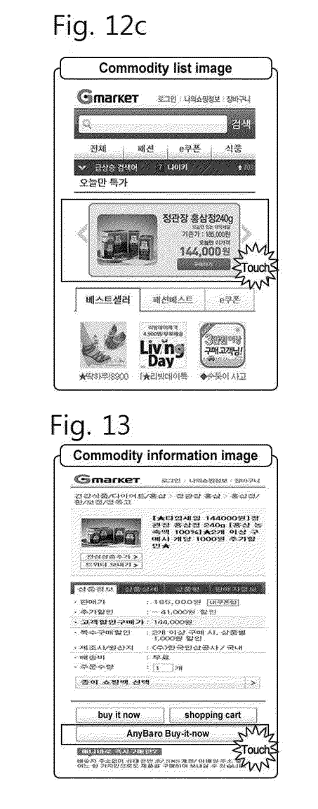

The orderer orders the commodity (gift) through the online shopping mall to which the gift delivery connection module is applied. FIGS. 12a to 12c show such ordering process. In FIGS. 12A to 12C, the gift-delivery dedicated application is applied to the smartphone.

FIG. 12A shows some applications (Facebook, Twitter, etc.) each of which is implemented in a channel form. If the orderer selects the gift delivery dedicated application (‘AnyBaro’ of the present invention), the list of affiliated online shopping malls (member online shopping malls) to which the gift delivery service module is applicable is displayed as shown in FIG. 12b. If the orderer selects one from among the online shopping mall list, the orderer gains access to the mobile website of the corresponding shopping mall so that he or she can select a desired commodity from among various commodities displayed on the mobile website. However, if the service application is not installed in the smartphone of the orderer, if the orderer does not use the application, or if the orderer UE is any other device than the smartphone, the orderer can directly connect to the online shopping mall of FIG. 12C, such that he or she can conveniently utilize the service of the present invention.

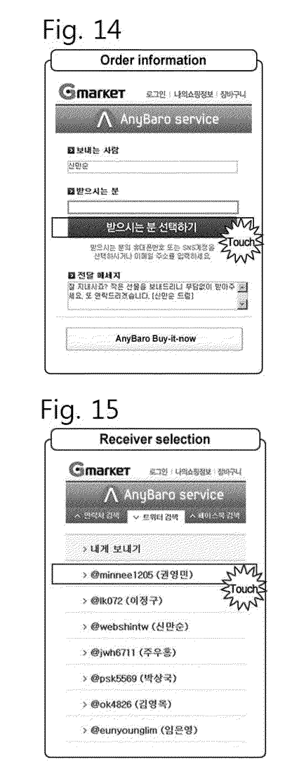

As can be seen from FIG. 13, if the orderer selects a commodity to be used as a gift from the online shopping mall, and clicks on a gift purchase menu (for example, AnyBaro buy-it-now menu of FIG. 13), an exemplary screen image for the receiver social-networking information is displayed on the UE as shown in FIG. 14. The orderer may directly input the receiver social-networking information, or may select receiver social-networking information types (i.e., a mobile phone number, SNS account, and the list based on e-mail). In this case, as can be seen from FIG. 15, the gift delivery service module calls the list for each social-networking information type, and displays the called list on the UE screen. Meanwhile, the orderer can also input a transmission message to be sent to the receiver. Herein, a variety of transmission messages may be provided in advance, such that the transmission message may be automatically input. In addition, the orderer may also command the service server to deliver the commodity to himself or herself, instead of delivering the commodity to another person.

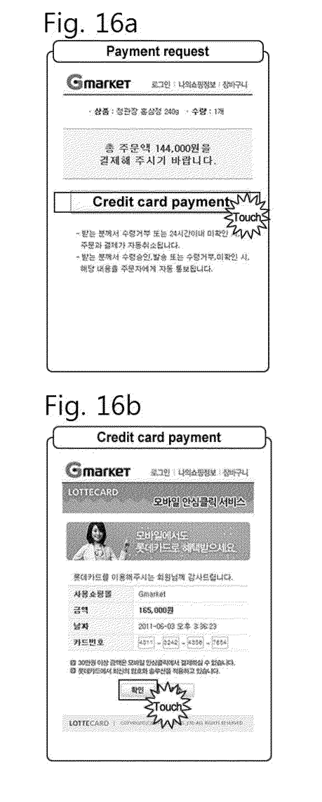

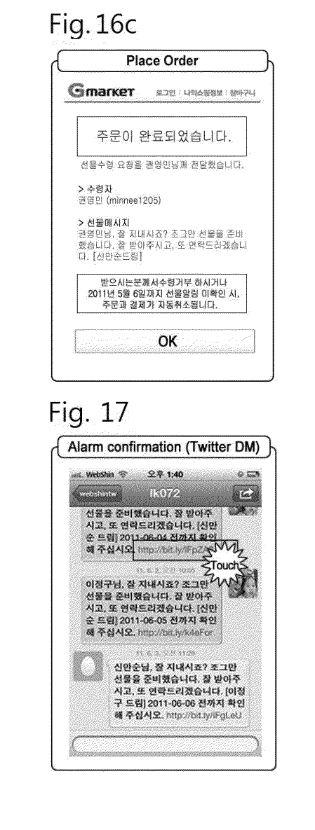

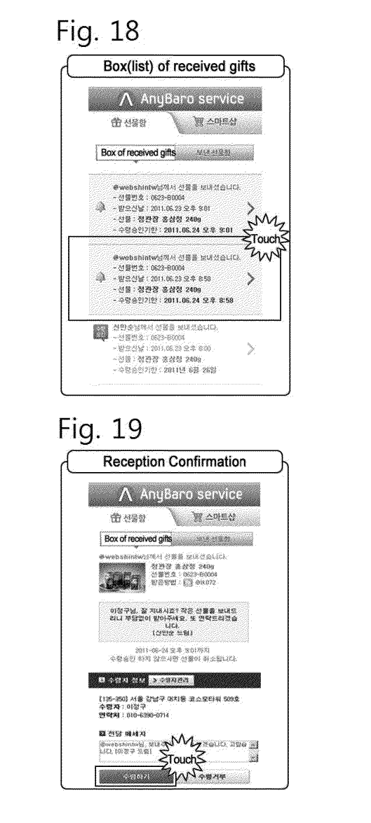

Once commodity and receiver selection is completed, the payment process starts, and a detailed description thereof will hereinafter be given, the payment request screen image is displayed as shown in FIG. 16a. If the payment confirmation button (‘OK’ button) is selected as shown in FIG. 16b, the order-complete (i.e., place order) screen image is displayed as shown in FIG. 16C. The payment processes shown in FIGS. 16a and 16b are similar to those of general online shopping malls. However, if the order process is completed as shown in FIG. 16C, not only the receiver social-networking information other than address information but also a transmission message is displayed as shown in FIG. 16C. Once payment is completed, order information including commodity information and receiver social-networking information is sent to the authentication server. The gift delivery authentication server can also authenticate the corresponding information and create an authentication URL including an authentication key in the same manner as in the aforementioned embodiments. The gift delivery authentication server can also authenticate the corresponding information and create an authentication URL including an authentication key, as previously stated in the aforementioned embodiments.

The gift arrival message including the created authentication URL is delivered to the receiver using any of the service dedicated application note, SNS note, SMS/MMS message, or e-mail. FIG. 17 exemplarily shows the gift arrival message including an authentication URL displayed on the receiver UE. FIG. 17 shows a Twitter DM (Direct Message) from among SNS notes.

If the service dedicated application is installed, the gift arrival message is immediately transmitted through an application note. If the dedicated application is not installed and the authentication URL is selected as shown in FIG. 17, the service dedicated application can be automatically downloaded and installed. On the other hand, if the current state is a device environment in which it is impossible to install the application, or if the receiver does not want to install the application, the receiver can access the AnyBaro web-service of the present invention.

If the gift arrival message is confirmed and a commodity information request is received from the receiver who has accessed the authentication URL, the gift delivery connection module retrieves commodity information and displays the retrieved commodity information on the UE as shown in FIG. 19.

As can be seen from FIG. 19, the commodity information may include a commodity picture, a commodity name, an orderer, a transmission message, a reception-acceptance deadline, etc. The orderer may request detailed information (commodity name, commodity image, etc.) of the commodity. If it is necessary to select option information (for example, color or size of the product) according to receiver preferences, the present invention can enable the service user to input a delivery address as well as to select optional information.

If the receiver wants to receive the gift, he or she must select reception acceptance and input reception address information. If the receiver inputs address information at every delivery, there arises greater inconvenience of the receiver. In order to allow the receiver to conveniently use the system, the receiver can enable address information to be stored according to their selection, and the receiver can automatically receive the gift using the address-automatic-acceptance option. In addition, the receiver may input the transmission message to the orderer. If the receiver does not confirm the gift arrival message or the authentication URL within a predetermined time, or if the receiver does not agree to receive the gift, the authentication server requests cancellation of the corresponding order such that payment cancellation is achieved as previously stated in the aforementioned embodiments.

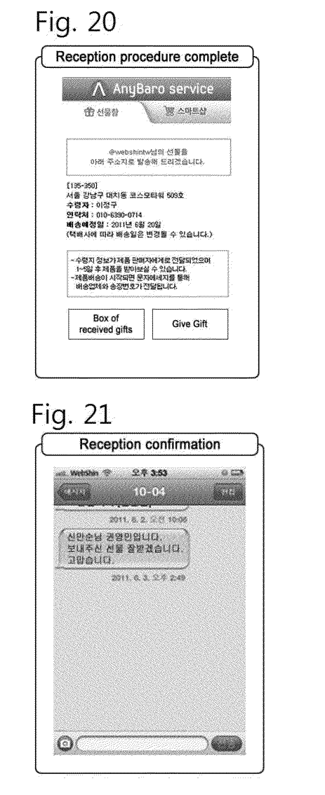

If the orderer selects a reception acceptance menu, the reception procedure complete screen image is displayed as shown in FIG. 20. If the reception acceptance is completed, a message informing the orderer of reception acceptance is transmitted to the orderer as shown in FIG. 21. Otherwise, if the receiver refuses the gift, a payment cancellation and denial message is transmitted to the orderer. If necessary, the orderer may also anonymously deliver the gift to the receiver using a specific option.

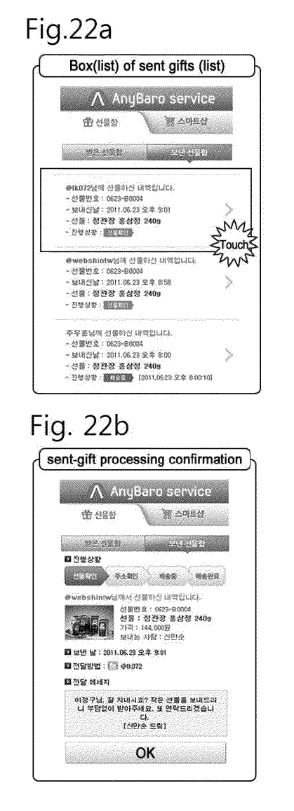

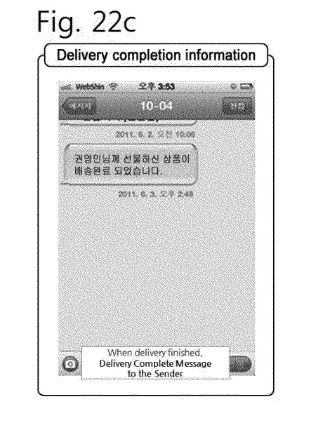

FIGS. 22A to 22C illustrate procedures needed for the orderer who confirms the sent gift. If a commodity is selected from among the list, a current delivery situation is displayed. If the delivery is completed, the delivery completion message is sent to the orderer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for delivering a gift to a receiver using social-networking information by an orderer who connects to an online shopping mall through an orderer user equipment (UE), the method comprising:
a) if a commodity to be used as a gift for a receiver is selected by the orderer UE, receiving, by a gift delivery connection module, social-networking information other than a reception address from a receiver UE;
b) if payment is completed, transmitting, by the gift delivery connection module, order information including commodity information and receiver social-networking information to a gift delivery authentication server;
c) authenticating, by the gift delivery authentication server, the order information received from the gift delivery connection module, and creating an authentication URL including an authentication key;
d) transmitting, by the gift delivery authentication server, a gift arrival message including the authentication URL to the receiver UE;
e) if the receiver UE accesses an authentication URL, selects reception acceptance and inputs reception address information, verifying, by the gift delivery authentication server, commodity reception intention of the receiver and validity of reception address, and transmitting delivery information to the gift delivery connection module upon completion of such verification; and
f) requesting, by the gift delivery connection module, commodity delivery from a delivery system.

2-59. (canceled)

60. The method according to claim 1, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

61. The method according to claim 1, wherein each of the orderer UE and the receiver UE is any one of a mobile phone, a smartphone, a PC, a tablet PC, a smart TV, and smart home appliances.

62. The method according to claim 61, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

63. The method according to claim 1, wherein the social-networking information is any one of an SNS (social network service) account, a phone number, and an e-mail address.

64. The method according to claim 63, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

65. The method according to claim 63, wherein:
in the step a), if the social-networking information is the e-mail address, the orderer directly inputs an e-mail address through the orderer UE.

66. The method according to claim 65, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

67. The method according to claim 63, wherein:
in the step a), provided that the social-networking information is a phone number; if gift-delivery dedicated application is installed on the orderer UE, the orderer selects a phone number from contact information stored in the orderer UE; and if the gift-delivery dedicated application is not installed, the orderer directly inputs a phone number.

68. The method according to claim 67, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

69. The method according to claim 63, wherein:
in the step a), provided that the social-networking information is an SNS account,
the gift delivery connection module requests a social-networking information list from the gift delivery authentication server; the gift delivery authentication server requests social-networking information registered in an SNS account of the orderer from the social network serving (SNS) server, and transmits the received social-networking information list to the gift delivery connection module; and the gift delivery connection module transmits the social-networking information list to the orderer UE.

70. The method according to claim 69, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

71. The method according to claim 1, wherein the order information including commodity information and receiver social-networking information of the step b) includes a shopping mall ID and a transmission message entered by the orderer UE.

72. The method according to claim 71, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

73. The method according to claim 1, wherein:
in the step a), provided that the social-networking information is a phone number; if gift-delivery dedicated application is installed on the orderer UE, the orderer selects a phone number from contact information stored in the orderer UE; and if the gift-delivery dedicated application is not installed, the orderer directly inputs a phone number.

74. The method according to claim 73, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

75. The method according to claim 1, wherein the step of transmitting the gift arrival message including the authentication URL of the step d) to the receiver UE includes transmitting the gift arrival message using any one of a gift-delivery dedicated application note, an SNS note, SMS/MMS messages, or e-mail.

76. The method according to claim 75, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

77. The method according to claim 1, wherein:
in the step e), if the gift arrival message from the receiver UE is not confirmed for a predetermined time or if the authentication URL is not accessed, the gift delivery authentication server requests order cancellation from the gift delivery service module, and the gift delivery service module having received the order cancellation request transmits a payment cancellation request from the online shopping mall.

78. The method according to claim 77, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

79. The method according to claim 1, wherein:
in the step e), the gift delivery authentication server transmits the gift arrival message to the receiver UE, and retransmits the gift arrival message to the receiver UE after lapse of a predetermined time.

80. The method according to claim 79, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

81. The method according to claim 1, wherein:
in the step e), if the receiver UE accesses the authentication URL so that commodity information is requested, the gift delivery authentication server verifies validity of the requested commodity information, and requests commodity information from the gift delivery connection module after completion of validity verification; and the gift delivery connection module confirms the presence or absence of validity of purchase details through an online shopping mall, creates a file, and transmits the created file to the receiver UE.

82. The method according to claim 81, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

83. The method according to claim 81, wherein:
if the receiver UE refuses to receive the commodity, the authentication server verifies validity of reception denial intention, and transmits the reception denial intention to the gift delivery connection module upon verification completion; and the gift delivery connection module transmits a payment cancellation request to the online shopping mall.

84. The method according to claim 83, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

85. The method according to claim 81, wherein:
if the receiver UE does not input a message of reception acceptance of the commodity during a predetermined time, the gift delivery authentication server determines that a purchaser desires to automatically refuse reception of the commodity, verifies validity of the reception denial intention, and transmits reception denial intention to the gift delivery connection module after verification completion, such that the gift delivery connection module transmits a payment cancellation request from the online shopping mall.

86. The method according to claim 85, wherein:
if the receiver UE selects reception acceptance or reception denial of the commodity or selects automatic order cancellation, the gift delivery authentication server transmits a reception acceptance message, a reception denial message, or an automatic order cancellation message to the orderer UE.

87. The method according to claim 1, wherein:
in the step e), if the receiver UE selects storing of the reception address, the gift delivery authentication server stores the reception address by the selection of the receiver, and delivers the commodity to the stored reception address.

88. A method for delivering a gift to a receiver using social-networking information by an orderer who connects to an online shopping mall through an orderer user equipment (UE), the method comprising:
a) if a commodity to be used as a gift for a receiver is selected by the orderer UE, receiving, by a gift delivery connection module, social-networking information other than a reception address from a receiver UE;
b) if payment is completed, transmitting, by the gift delivery connection module, order information including commodity information and receiver social-networking information to a gift delivery authentication server;
c) authenticating, by the gift delivery authentication server, the order information received from the gift delivery connection module, and creating an authentication URL including an authentication key;
d) if the gift delivery authentication server transmits the created authentication URL to the gift delivery connection module, creating a gift arrival message including the authentication URL by the gift delivery connection module, and transmitting the created gift arrival message to the receiver UE;
e) if the receiver UE accesses an authentication URL and commodity information is requested, verifying, by the gift delivery connection module, validity of the requested commodity information, confirming whether purchase details from the online shopping mall are valid or not after completion of validity verification, creating a file, and transmitting commodity information to the receiver UE; and
f) if the receiver UE selects reception acceptance and inputs a reception address, receiving, by the gift delivery connection module, delivery information including the reception address and verifying commodity acceptance intention and validity of the reception address, and transmitting a commodity delivery request to the delivery system after completion of the verification.

89. The method according to claim 88, wherein:
in the step e), if the receiver UE does not confirm the gift arrival message during a predetermined time or does not access the authentication URL, the gift delivery connection module transmits a payment cancellation request to the online shopping mall.

90. The method according to claim 88, wherein:
in the step f), if the receiver UE refuses to receive the commodity, the gift delivery connection module verifies validity of reception denial intention, and transmits the reception denial intention to the gift delivery connection module upon verification completion; and the gift delivery connection module transmits a payment cancellation request to the online shopping mall.

91. The method according to claim 88, wherein:
if the receiver UE does not input a message of reception acceptance of the commodity during a predetermined time, the gift delivery connection module determines that a purchaser desires to automatically refuse reception of the commodity, verifies validity of the reception denial intention, and transmits a payment cancellation request to the online shopping mall after verification completion.

92. The method according to claim 88, wherein each of the orderer UE and the receiver UE is any one of a mobile phone, a smartphone, a PC, a tablet PC, a smart TV, and smart home appliances.

93. The method according to claim 88, wherein the social-networking information is any one of an SNS (social network service) account, a phone number, and an e-mail address.

94. The method according to claim 88, wherein:
in the step a), if the social-networking information is the e-mail address, the orderer directly inputs an e-mail address through the orderer UE.

95. The method according to claim 88, wherein:
in the step a), provided that the social-networking information is a phone number; if gift-delivery dedicated application is installed on the orderer UE, the orderer selects a phone number from contact information stored in the orderer UE; and if the gift-delivery dedicated application is not installed, the orderer directly inputs a phone number.

96. The method according to claim 88, wherein:
in the step a), provided that the social-networking information is an SNS account,
the gift delivery connection module requests a social-networking information list from the gift delivery authentication server; the gift delivery authentication server requests social-networking information registered in an SNS account of the orderer from the social network serving (SNS) server, and transmits the received social-networking information list to the gift delivery connection module; and the gift delivery connection module transmits the social-networking information list to the orderer UE.

97. The method according to claim 88, wherein the order information including commodity information and receiver social-networking information of the step b) includes a shopping mall ID and a transmission message entered by the orderer UE.

98. The method according to claim 88, wherein the step c) includes:
creating and storing an authentication URL including an authentication key by encrypting the order information,
wherein the authentication URL is any one of a download address of an application for directing the receiver to input the reception address using the receiver UE, a URL address of a site for informing the gift delivery authentication server of an acceptance or denial message of the receiver, or a URL address for connecting to the gift delivery authentication server.

99. The method according to claim 88, wherein the step of transmitting the gift arrival message including the authentication URL of the step d) to the receiver UE includes transmitting the gift arrival message using any one of a gift-delivery dedicated application note, an SNS note, SMS/MMS messages, or e-mail.

100. The method according to claim 88, wherein:
in the step e), the gift delivery authentication server transmits the gift arrival message to the receiver UE, and retransmits the gift arrival message to the receiver UE after lapse of a predetermined time.

101. A method for delivering a gift to a receiver using social-networking information by an orderer who connects to an online shopping mall through an orderer user equipment (UE), the method comprising:
a) if a commodity to be used as a gift for a receiver is selected by the orderer UE, receiving, by a gift delivery connection module, social-networking information other than a reception address from a receiver UE;
b) if payment is completed, transmitting, by the gift delivery connection module, order information including commodity information and receiver social-networking information to a gift delivery authentication server;
c) authenticating, by the gift delivery authentication server, the order information received from the gift delivery connection module, and creating an authentication URL including an authentication key;
d) if the gift delivery authentication server transmits the created authentication URL to the gift delivery connection module, creating a gift arrival message including the authentication URL by the gift delivery connection module, and transmitting the created gift arrival message to the receiver UE;
e) if the receiver UE accesses an authentication URL and commodity information is requested, verifying, by the gift delivery connection module, validity of the requested commodity information, confirming whether purchase details from the online shopping mall are valid or not after completion of validity verification, creating a file, and transmitting commodity information to the receiver UE; and
f) if the receiver UE selects reception acceptance and inputs a reception address, receiving, by the gift delivery connection module, delivery information including the reception address and verifying commodity acceptance intention and validity of the reception address, and transmitting a commodity delivery request to the delivery system after completion of the verification.

102. The method according to claim 101, wherein:
in the step e), if the receiver UE does not confirm the gift arrival message during a predetermined time or does not access the authentication URL, the gift delivery connection module transmits a payment cancellation request to the online shopping mall.

103. The method according to claim 101, wherein:
in the step f), if the receiver UE refuses to receive the commodity, the gift delivery connection module verifies validity of reception denial intention, and transmits the reception denial intention to the gift delivery connection module upon verification completion; and the gift delivery connection module transmits a payment cancellation request to the online shopping mall.

104. The method according to claim 101, wherein:
if the receiver UE does not input a message of reception acceptance of the commodity during a predetermined time, the gift delivery connection module determines that a purchaser desires to automatically refuse reception of the commodity, verifies validity of the reception denial intention, and transmits a payment cancellation request to the online shopping mall after verification completion.

105. The method according to claim 101, wherein each of the orderer UE and the receiver UE is any one of a mobile phone, a smartphone, a PC, a tablet PC, a smart TV, and smart home appliances.

106. The method according to claim 101, wherein the social-networking information is any one of an SNS (social network service) account, a phone number, and an e-mail address.

107. The method according to claim 101, wherein:
in the step a), if the social-networking information is the e-mail address, the orderer directly inputs an e-mail address through the orderer UE.

108. The method according to claim 101, wherein:
in the step a), provided that the social-networking information is a phone number; if gift-delivery dedicated application is installed on the orderer UE, the orderer selects a phone number from contact information stored in the orderer UE; and if the gift-delivery dedicated application is not installed, the orderer directly inputs a phone number.

109. The method according to claim 101, wherein:
in the step a), provided that the social-networking information is an SNS account,
the gift delivery connection module requests a social-networking information list from the gift delivery authentication server; the gift delivery authentication server requests social-networking information registered in an SNS account of the orderer from the social network serving (SNS) server, and transmits the received social-networking information list to the gift delivery connection module; and the gift delivery connection module transmits the social-networking information list to the orderer UE.

110. The method according to claim 101, wherein the order information including commodity information and receiver social-networking information of the step b) includes a shopping mall ID and a transmission message entered by the orderer UE.

111. The method according to claim 101, wherein the step c) includes:
creating and storing an authentication URL including an authentication key by encrypting the order information,
wherein the authentication URL is any one of a download address of an application for directing the receiver to input the reception address using the receiver UE, a URL address of a site for informing the gift delivery authentication server of an acceptance or denial message of the receiver, or a URL address for connecting to the gift delivery authentication server.

112. The method according to claim 101, wherein the step of transmitting the gift arrival message including the authentication URL of the step d) to the receiver UE includes transmitting the gift arrival message using any one of a gift-delivery dedicated application note, an SNS note, SMS/MMS messages, or e-mail.

113. The method according to claim 101, wherein:
in the step e), the gift delivery authentication server transmits the gift arrival message to the receiver UE, and retransmits the gift arrival message to the receiver UE after lapse of a predetermined time.

114. A method for delivering a gift to a receiver using social-networking information by an orderer who connects to an online shopping mall through an orderer user equipment (UE), the method comprising:
a) if a commodity to be used as a gift for a receiver is selected by the orderer UE, receiving, by a gift delivery connection module, social-networking information other than a reception address from a receiver UE;
b) if payment is completed, transmitting, by the gift delivery connection module, order information including commodity information and receiver social-networking information to a gift delivery authentication server;
c) authenticating, by the gift delivery authentication server, the order information received from the gift delivery connection module, and creating an authentication URL including an authentication key;
d) if the gift delivery authentication server transmits the created authentication URL to the gift delivery connection module, creating a gift arrival message including the authentication URL by the gift delivery connection module, and transmitting the created gift arrival message to the receiver UE;
e) if the receiver UE accesses an authentication URL and commodity information is requested, verifying, by the gift delivery connection module, validity of the requested commodity information, confirming whether purchase details from the online shopping mall are valid or not after completion of such verification, creating a file, and transmitting commodity information to the receiver UE;
f) if the receiver UE selects reception acceptance and inputs a reception address, receiving, by the gift delivery authentication server module, delivery information including the reception address and verifying commodity acceptance intention and validity of the reception address, and transmitting a commodity delivery request to the delivery system after completion of the verification; and
g) transmitting, by the gift delivery connection module, a commodity delivery request to a delivery system.

115. The method according to claim 114, wherein:
in the step e), if the gift arrival message from the receiver UE is not confirmed for a predetermined time or if the authentication URL is not accessed, the gift delivery connection module transmits a payment cancellation request to the online shopping mall.

116. The method according to claim 114, wherein:
in the step f), if the receiver UE refuses to receive the commodity, the gift delivery authentication server verifies validity of reception denial intention, and transmits the reception denial intention to the gift delivery connection module upon verification completion; and the gift delivery connection module transmits a payment cancellation request to the online shopping mall.

117. The method according to claim 114, wherein:
if the receiver UE does not input a message of reception acceptance of the commodity during a predetermined time, the gift delivery connection module determines that a purchaser desires to automatically refuse reception of the commodity, verifies validity of the reception denial intention, and transmits a payment cancellation request to the online shopping mall after verification completion.

118. The method according to claim 114, wherein each of the orderer UE and the receiver UE is any one of a mobile phone, a smartphone, a PC, a tablet PC, a smart TV, and smart home appliances.

119. The method according to claim 114, wherein the social-networking information is any one of an SNS (social network service) account, a phone number, and an e-mail address.

120. The method according to claim 114, wherein:
in the step a), if the social-networking information is the e-mail address, the orderer directly inputs an e-mail address through the orderer UE.

121. The method according to claim 114, wherein:
in the step a), provided that the social-networking information is a phone number; if gift-delivery dedicated application is installed on the orderer UE, the orderer selects a phone number from contact information stored in the orderer UE; and if the gift-delivery dedicated application is not installed, the orderer directly inputs a phone number.

122. The method according to claim 114, wherein:
in the step a), provided that the social-networking information is an SNS account, the gift delivery connection module requests a social-networking information list from the gift delivery authentication server; the gift delivery authentication server requests social-networking information registered in an SNS account of the orderer from the social network serving (SNS) server, and transmits the received social-networking information list to the gift delivery connection module; and the gift delivery connection module transmits the social-networking information list to the orderer UE.

123. The method according to claim 114, wherein the order information including commodity information and receiver social-networking information of the step b) includes a shopping mall ID and a transmission message entered by the orderer UE.

124. The method according to claim 114, wherein the step c) includes:
creating and storing an authentication URL including an authentication key by encrypting the order information,
wherein the authentication URL is any one of a download address of an application for directing the receiver to input the reception address using the receiver UE, a URL address of a site for informing the gift delivery authentication server of an acceptance or denial message of the receiver, or a URL address for connecting to the gift delivery authentication server.

125. The method according to claim 114, wherein the step of creating, by the gift delivery connection module of the step d), the gift arrival message including an authentication URL and transmitting the created gift arrival message to the receiver UE includes transmitting the gift arrival message using any one of a gift-delivery dedicated application note, an SNS note, SMS/MMS messages, or e-mail.

126. The method according to claim 114, wherein:
in the step e), the gift delivery connection module transmits the gift arrival message to the receiver UE, and retransmits the gift arrival message to the receiver UE after lapse of a predetermined time.

127. A method for delivering a gift using social-networking information using a gift delivery system which communicates with an orderer user equipment (UE), a receiver UE, and a service networking service (SNS) server and an online shopping mall server over a wired or wireless commodity network, the method comprising:
a) receiving, by the gift delivery system, information of a commodity to be used as a gift for a receiver and social-networking information other than a reception address of the receiver from the orderer UE connecting to the online shopping mall;
b) if payment is completed by the orderer UE, transmitting, authenticating, by the gift delivery system, order information including the commodity information and the receiver, and creating authentication information;
c) transmitting, by the gift delivery system, a gift arrival message to the receiver UE; and
d) if the receiver UE confirms the gift arrival message, selects reception acceptance, and inputs a reception address, requesting, by the gift delivery system, commodity delivery from a delivery system.

128. The method according to claim 127, wherein:
if the receiver UE selects reception acceptance or reception denial of the commodity or selects automatic order cancellation, the gift delivery system transmits a reception acceptance message, a reception denial message, or an automatic order cancellation message to the orderer UE.

129. The method according to claim 127, wherein each of the orderer UE and the receiver UE is any one of a mobile phone, a smartphone, a PC, a tablet PC, a smart TV, and smart home appliances.

130. The method according to claim 129, wherein:
if the receiver UE selects reception acceptance or reception denial of the commodity or selects automatic order cancellation, the gift delivery system transmits a reception acceptance message, a reception denial message, or an automatic order cancellation message to the orderer UE.

131. The method according to claim 127, wherein the social-networking information is any one of an SNS (social network service) account, a phone number, and an e-mail address.

132. The method according to claim 131, wherein:
if the receiver UE selects reception acceptance or reception denial of the commodity or selects automatic order cancellation, the gift delivery system transmits a reception acceptance message, a reception denial message, or an automatic order cancellation message to the orderer UE.

133. The method according to claim 127, wherein:
the step a) of receiving social-networking information other than the reception address of the receiver from the orderer UE allows the gift delivery system to directly receive the receiver social-networking information from the orderer UE or allows the orderer to select social-networking information type upon receiving a request from the orderer, in which, upon receiving a selection request of social-networking information type from the orderer, the gift delivery system requests social-networking information registered in an SNS account of the orderer from the SNS server, and transmits a list of the received social-networking information to the orderer UE.

134. The method according to claim 133, wherein:
if the receiver UE selects reception acceptance or reception denial of the commodity or selects automatic order cancellation, the gift delivery system transmits a reception acceptance message, a reception denial message, or an automatic order cancellation message to the orderer UE.

135. The method according to claim 127, wherein the authentication information of the step b) includes an authentication URL including an authentication key,
wherein the authentication URL is any one of a download address of an application for directing the receiver to input the reception address using the receiver UE, a URL address of a site for informing the gift delivery system of an acceptance or denial message of the receiver, or a URL address for connecting to the gift delivery system.

136. The method according to claim 135, wherein:
if the receiver UE selects reception acceptance or reception denial of the commodity or selects automatic order cancellation, the gift delivery system transmits a reception acceptance message, a reception denial message, or an automatic order cancellation message to the orderer UE.

137. The method according to claim 127, wherein the gift arrival message transmitted to the receiver UE in the step (c) is any one of a gift-delivery dedicated application note, an SNS note, SMS/MMS messages, or e-mail.

138. The method according to claim 137, wherein:
if the receiver UE selects reception acceptance or reception denial of the commodity or selects automatic order cancellation, the gift delivery system transmits a reception acceptance message, a reception denial message, or an automatic order cancellation message to the orderer UE.

139. The method according to claim 127, wherein:
in the step d), if the gift arrival message from the receiver UE is not confirmed for a predetermined time, if authentication information is not accessed, or if reception acceptance is not selected by the receiver UE during a predetermined time, the gift delivery system transmits a payment cancellation request to the online shopping mall.

140. The method according to claim 139, wherein:
if the receiver UE selects reception acceptance or reception denial of the commodity or selects automatic order cancellation, the gift delivery system transmits a reception acceptance message, a reception denial message, or an automatic order cancellation message to the orderer UE.

141. The method according to claim 127, wherein:
in the step d), if the receiver UE accesses the authentication URL so that commodity information is requested, the gift delivery system requests commodity information from the online shopping mall server, and transmits the received information to the receiver UE.

142. The method according to claim 141, wherein:
if the receiver UE selects reception acceptance or reception denial of the commodity or selects automatic order cancellation, the gift delivery system transmits a reception acceptance message, a reception denial message, or an automatic order cancellation message to the orderer UE.

143. The method according to claim 127, wherein:
in the step d), if the receiver UE refuses to receive the commodity, the gift delivery system transmits a payment cancellation request to the online shopping mall.

144. The method according to claim 143, wherein:
if the receiver UE selects reception acceptance or reception denial of the commodity or selects automatic order cancellation, the gift delivery system transmits a reception acceptance message, a reception denial message, or an automatic order cancellation message to the orderer UE.

145. The method according to claim 127, wherein:
if the receiver UE selects storing of the reception address,
the gift delivery system stores the reception address, and delivers the commodity to the stored reception address by the selection of the receiver.

146. A system for delivering a gift using social-networking information by a gift delivery system which communicates with an orderer user equipment (UE), a receiver UE, and a service networking service (SNS) server and an online shopping mall server over a wired or wireless commodity network, the system comprising:
a gift delivery connection module, if an orderer selects a commodity to be used as a gift for a receiver in an online shopping mall through the orderer UE, for displaying an information image on the orderer UE in such a manner that the orderer selects/inputs social-networking information other than a reception address of a receiver using the displayed information image; and
a gift delivery authentication server for receiving order information including commodity information and social-networking information from the gift delivery connection module, authenticating the received order information, creating an authentication URL, and transmitting a gift arrival message including the authentication URL to the receiver UE,
wherein the gift delivery authentication server, if the receiver UE accesses an authentication URL, selects reception acceptance and inputs reception address information, verifies validity of delivery information associated with the selected/input information, transmits the result of verification to the gift delivery connection module, and enables the gift delivery connection module to request commodity delivery from the delivery system on the basis of the transmitted delivery information.

147. The system according to claim 146, wherein each of the orderer UE and the receiver UE is any one of a mobile phone, a smartphone, a PC, a tablet PC, a smart TV, and smart home appliances.

148. The system according to claim 146, wherein the social-networking information is any one of an SNS (social network service) account, a phone number, and an e-mail address.

149. The system according to claim 146, wherein:
the gift delivery connection module enables the orderer to select social-networking information type upon receiving a request from the orderer, and requests a social-networking information list from the gift delivery authentication server upon receiving a selection request of social-networking information type from the orderer, and
the gift delivery authentication server requests social-networking information registered in an SNS account of the orderer from the SNS server, and transmits a list of the received social-networking information to the orderer UE.

150. The system according to claim 146, wherein the authentication URL is any one of a download address of an application for directing the receiver to input the reception address using the receiver UE, a URL address of a site for informing the gift delivery system of an acceptance or denial message of the receiver, or a URL address for connecting to the gift delivery system.

151. The system according to claim 146, wherein the gift arrival message transmitted to the receiver UE is any one of a gift-delivery dedicated application note, an SNS note, SMS/MMS messages, or e-mail.

152. The system according to claim 146, wherein:
if the user UE accesses an authentication URL and requests commodity information, the gift delivery connection module verifies validity of the requested commodity information, requests the commodity information from the online shopping mall, and transmits the received commodity information to the receiver UE.

153. The system according to claim 152, wherein each of the orderer UE and the receiver UE is any one of a mobile phone, a smartphone, a PC, a tablet PC, a smart TV, and smart home appliances.

154. The system according to claim 152, wherein the social-networking information is any one of an SNS (social network service) account, a phone number, and an e-mail address.

155. The system according to claim 152, wherein:
the gift delivery connection module enables the orderer to select social-networking information type upon receiving a request from the orderer, and requests a social-networking information list from the gift delivery authentication server upon receiving a selection request of social-networking information type from the orderer, and
the gift delivery authentication server requests social-networking information registered in an SNS account of the orderer from the SNS server, and transmits a list of the received social-networking information to the orderer UE.

156. The system according to claim 152, wherein the authentication URL is any one of a download address of an application for directing the receiver to input the reception address using the receiver UE, a URL address of a site for informing the gift delivery system of an acceptance or denial message of the receiver, or a URL address for connecting to the gift delivery system.

157. The system according to claim 152, wherein the gift arrival message transmitted to the receiver UE is any one of a gift-delivery dedicated application note, an SNS note, SMS/MMS messages, or e-mail.

158. The system according to claim 146, wherein:
if the user UE accesses an authentication URL and requests commodity information, the gift delivery connection module verifies validity of the requested commodity information, requests the commodity information from the online shopping mall, and transmits the received commodity information to the receiver UE.

159. The system according to claim 158, wherein each of the orderer UE and the receiver UE is any one of a mobile phone, a smartphone, a PC, a tablet PC, a smart TV, and smart home appliances.

160. The system according to claim 158, wherein the social-networking information is any one of an SNS (social network service) account, a phone number, and an e-mail address.

161. The system according to claim 158, wherein:
the gift delivery connection module enables the orderer to select social-networking information type upon receiving a request from the orderer, and requests a social-networking information list from the gift delivery authentication server upon receiving a selection request of social-networking information type from the orderer, and
the gift delivery authentication server requests social-networking information registered in an SNS account of the orderer from the SNS server, and transmits a list of the received social-networking information to the orderer UE.

162. The system according to claim 158, wherein the authentication URL is any one of a download address of an application for directing the receiver to input the reception address using the receiver UE, a URL address of a site for informing the gift delivery system of an acceptance or denial message of the receiver, or a URL address for connecting to the gift delivery system.

163. The system according to claim 158, wherein the gift arrival message transmitted to the receiver UE is any one of a gift-delivery dedicated application note, an SNS note, SMS/MMS messages, or e-mail.

164. A system for delivering a gift using social-networking information by a gift delivery system which communicates with an orderer user equipment (UE), a receiver UE, and a service networking service (SNS) server and an online shopping mall server over a wired or wireless commodity network, the system comprising:
a gift delivery connection module, if an orderer selects a commodity to be used as a gift for a receiver in an online shopping mall through the orderer UE, for displaying an information image on the orderer UE in such a manner that the orderer selects/inputs social-networking information other than a reception address of a receiver using the displayed information image; and
a gift delivery authentication server for receiving order information including commodity information and social-networking information from the gift delivery connection module, authenticating the received order information, creating an authentication URL, and transmitting the created authentication URL to the gift arrival connection module,
wherein the gift delivery connection module creates a gift arrival message including the received authentication URL and transmits the created gift arrival message to a purchaser UE, verifies validity of delivery information when the receiver UE accesses an authentication URL, selects reception acceptance, and inputs a reception address, and requests commodity delivery from a delivery system on the basis of the delivery information.

165. The system according to claim 164, wherein each of the orderer UE and the receiver UE is any one of a mobile phone, a smartphone, a PC, a tablet PC, a smart TV, and smart home appliances.

166. The system according to claim 164, wherein the social-networking information is any one of an SNS (social network service) account, a phone number, and an e-mail address.

167. The system according to claim 164, wherein:
the gift delivery connection module enables the orderer to select social-networking information type upon receiving a request from the orderer, and requests a social-networking information list from the gift delivery authentication server upon receiving a selection request of social-networking information type from the orderer, and
the gift delivery authentication server requests social-networking information registered in an SNS account of the orderer from the SNS server, and transmits a list of the received social-networking information to the orderer UE.

168. The system according to claim 164, wherein the authentication URL is any one of a download address of an application for directing the receiver to input the reception address using the receiver UE, a URL address of a site for informing the gift delivery system of an acceptance or denial message of the receiver, or a URL address for connecting to the gift delivery system.

169. The system according to claim 164, wherein the gift arrival message transmitted to the receiver UE is any one of a gift-delivery dedicated application note, an SNS note, SMS/MMS messages, or e-mail.

170. The system according to claim 164, wherein:
if the user UE accesses an authentication URL and requests commodity information, the gift delivery authentication server verifies validity of the requested commodity information, and transmits the result of verification to the gift delivery connection module; and the gift delivery connection module requests commodity information from the online shopping mall and transmits the received commodity information to the receiver UE.

171. The system according to claim 170, wherein each of the orderer UE and the receiver UE is any one of a mobile phone, a smartphone, a PC, a tablet PC, a smart TV, and smart home appliances.

172. The system according to claim 170, wherein the social-networking information is any one of an SNS (social network service) account, a phone number, and an e-mail address.

173. The system according to claim 170, wherein:
the gift delivery connection module enables the orderer to select social-networking information type upon receiving a request from the orderer, and requests a social-networking information list from the gift delivery authentication server upon receiving a selection request of social-networking information type from the orderer, and
the gift delivery authentication server requests social-networking information registered in an SNS account of the orderer from the SNS server, and transmits a list of the received social-networking information to the orderer UE.

174. The system according to claim 170, wherein the authentication URL is any one of a download address of an application for directing the receiver to input the reception address using the receiver UE, a URL address of a site for informing the gift delivery system of an acceptance or denial message of the receiver, or a URL address for connecting to the gift delivery system.

175. The system according to claim 170, wherein the gift arrival message transmitted to the receiver UE is any one of a gift-delivery dedicated application note, an SNS note, SMS/MMS messages, or e-mail.

176. The system according to claim 164, wherein:
if the user UE accesses an authentication URL and requests commodity information, the gift delivery authentication server verifies validity of the requested commodity information, and transmits the result of verification to the gift delivery connection module; and the gift delivery connection module requests commodity information from the online shopping mall and transmits the received commodity information to the receiver UE.

177. The system according to claim 176, wherein each of the orderer UE and the receiver UE is any one of a mobile phone, a smartphone, a PC, a tablet PC, a smart TV, and smart home appliances.

178. The system according to claim 176, wherein the social-networking information is any one of an SNS (social network service) account, a phone number, and an e-mail address.

179. The system according to claim 176, wherein:
the gift delivery connection module enables the orderer to select social-networking information type upon receiving a request from the orderer, and requests a social-networking information list from the gift delivery authentication server upon receiving a selection request of social-networking information type from the orderer, and
the gift delivery authentication server requests social-networking information registered in an SNS account of the orderer from the SNS server, and transmits a list of the received social-networking information to the orderer UE.

180. The system according to claim 176, wherein the authentication URL is any one of a download address of an application for directing the receiver to input the reception address using the receiver UE, a URL address of a site for informing the gift delivery system of an acceptance or denial message of the receiver, or a URL address for connecting to the gift delivery system.

181. The system according to claim 176, wherein the gift arrival message transmitted to the receiver UE is any one of a gift-delivery dedicated application note, an SNS note, SMS/MMS messages, or e-mail.
